SEQUENCE LISTING (23 sequences)

SEQ ID NO: 1 - protein, 275 aa, Bacillus amyloliquefaciens [sequence omitted]

SEQ ID NO: 2 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 3 - protein, 269 aa, synthetic construct
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 4 - protein, 274 aa, Bacillus licheniformis
AQTVPYGIPLIKADKVQAQGFKGANVKVAVLDTGIQASHPDLNVVGGASFVAGEAYNTDGNGHGTHVAGTVAALDNTTGVLGVAPSVSLYAVKVLNSSGSGSYSGIVSGIEWATTNGMDVINMSLGGASGSTAMKQAVDNAYARGVVVVAAAGNSGSSGNTNTIGYPAKYDSVIAVGAVDSNSNRASFSSVGAELEVMAPGAGVYSTYPTNTYATLNGTSMASPHVAGAAALILSKHPNLSASQVRNRLSSTATYLGSSFYYGKGLINVEAAAQ

SEQ ID NO: 5 - protein, 274 aa, synthetic construct
AQTVPYGIPLIKADKVQAQGFKGANVKVAVLDTGIQASHPDLNVVGGASFVAGEAYNTDGNGHGTHVSGTVAALDNNIGVLGVAPSVSLYAVKVLNSSGSGSYSGIVSGIEWATTNGMDVINMSLGSPSGSTAMKQAVDNAYARGVVVVAAAGNSGSSGNTNTIQYPAKYDSVIAVGAVDSNSQRASFSSVGAELEVMAPGVGVYSTYPTNTYATLSGTSMASPHVAGAAALILSKHPNLSASQVRNRLSSTATYLGPSFYYGKGLINVEAAAQ

SEQ ID NO: 6 - protein, 309 aa, Alkalihalobacillus bogoriensis
ANSGFYVSGTTLYDANGNPFVMRGINHGHTWYKDQATTAIEGIANTGANTVRIVLSDGGQWTKDDIHTVRNLISLAEDNHLVAVLEVHDATGQDDIASLNRAVDYWIEMRSALIGKEKTVIINIANEWFGSWEGDPWARGYKQAIPRLRNAGLNHTLMVDAAGWGQFPQSIHDYGREVFNADPQRNTMFSIHMYEYAGGTARQVRTNIDGVLNQDLALVIGEFGHRHTNGDVDEATIMSYSEQRGVGWLAWSWKGNGPEFEYLDLSNDWAGNNLTAWGNTIVHGPYGIRETSRPVTVFTGGGSDGGTSP

SEQ ID NO: 7 - protein, 309 aa, Alkalihalobacillus bogoriensis
ANSGFYVSGTTLYDANGNPFVMRGINHGHAWYKDQATTAIEGIANTGANTVRIVLSDGGQWTKDDIHTVRNLISLAEDNHLVAVLEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFTGGGSDGGTSP

SEQ ID NO: 8 - protein, 474 aa, unidentified
AQNQPIIATFEDASLEGYGIEKRDEATAKAMDPLYDGTGYISYFFEEDPKATVPPGSATFEVKAPETGLYELSLGYYIPEGNGDKLTEIQVNGSGPGELTLSEPAPGTVRAEKKMTKVLLNAGNNRIRILRGWGYYGIEHIKLELVDARIPPDKTIIDPLSNPKATREAKALMKYMTNQYGDKIISGQQTLEDAAWIYRETGKWPALVSSDLMDYSPSRVENGATSNEAEKMIEWYKAGGIVGLSWHWNAPKGIGGNEPGCEWWKGFYTECTTFDVEYALNHPWSEDYKLLIRDIDAIATQLKRLQEHKIPVLWRPLHEAEGGWFWWGAKGPEPAKKLYRLMYERLTEKHNLNNLIWVWNSVQEEWYPGHDVVDMVSVDIYNPPGDYSPNIAMYMELTFLSKHKKLVALAENGPIPDPDLLQTYGAHWSYFNTWTGDVLRDGKTNTKEHLKKVYNHDYVITLDELPKGLYESPR

SEQ ID NO: 9 - protein, 474 aa, unidentified
AQNQPIIATFEDASLEGYGIEKRDEATAKAMDPLYDGTGYISYFFEEDPKATVPPGSATFTVKAPENGLYELSLGYYIPEGNGDKLTEIQVNGSGPVELTLSEPAPGTVRAEKKMTKVLLNAGNNRIRILRGWGYYGIEHIKLELVDARIPPDKTIIDPLSNPKASREAKALMKYMTNQYGDKIISGQQTLEDAAWIYRETGKWPALVSSDLMDYSPSRVENGATSNEAEKMIEWYKAGGIVGLSWHWNAPKGIGGNEPGCEWWKGFYTECTTFDVEYALNHPWSEDYKLLIRDIDAIATQLKRLQEHKIPVLWRPLHEAEGGWFWWGAKGPEPAKKLYRLMYERLTEKHNLNNLIWVWNSVQEEWYPGHDVVDMVSVDIYNPPGDYSPNIAMYMELTFLSKHKKLVALAENGPIPDPDLLQTYGAHWSYFNTWTGDVLRDGKTNTKEHLKKVYNHDYVITLDELPKGLYESPR

SEQ ID NO: 10 - protein, 289 aa, unidentified
QNGFHVSGTELLDKNGDPYVMRGINHGHSWFKQDLEEAIPAIAETGANTVRMVLSNGQQWEKDDASELARVLAATETYGLTTVLEVHDATGSDDPADLEKAVDYWIEMADVLKGTEDRVIINVANEWYGSWRSDVWAEAYAQAIPRLRSAGLSHTLMVDAAGWGQYPASIHERGADVFASDPLKNTMFSIHMYEYAGADRATIAYNIDRVLAENLAVVIGEFGHRHHDGDVDEDAILAYTAERQVGWLAWSWYGNGGGVEYLDLAEGPSGPLTSWGKRIVYGENGLKSD

SEQ ID NO: 11 - protein, 299 aa, Bacillus sp.
ASGFYVSGTILCDSTGNPFKIRGINHAHSWFKNDSATAMEAIAATGANTVRIVLSNGQQYAKDDANTVSNLLSLANQHKLIAILEVHDATGSDSVSALDHAVDYWIEMKNVLVGKEDRVLINIANEWYGTWDSNGWADGYKSAIPKLRNAGINHTLIVDAAGWGQYPQSIVDKGNEVFNSDPLRNTIFSIHMYEYAGGNADMVRANIDQVLNKGLAVIIGEFGHYHTGGDVDETAIMSYTQQKGVGWLAWSWKGNGAEWLYLDLSYDWAGNHLTEWGETIVNGANGLKATSTRAPIFGN

SEQ ID NO: 12 - protein, 297 aa, Paenibacillus sp.
MATGFYVSGNKLYDSTGKPFVMRGVNHGHSWFKNDLNTAIPAIAKTGANTVRIVLSNGSLYTKDDLNAVKNIINVVNQNKMIAVLEVHDATGKDDYNSLDAAVNYWISIKEALIGKEDRVIVNIANEWYGTWNGSAWADGYKKAIPKLRNAGIKNTLIVDAAGWGQFPQSIVDYGQSVFAADSQKNTVFSIHMYEYAGKDAATVKANMENVLNKGLALIIGEFGGYHTNGDVDEYAIMRYGQEKGVGWLAWSWYGNSSGLNYLDMATGPNGSLTSFGNTVVNDTYGIKNTSQKAGIF

SEQ ID NO: 13 - protein, 278 aa, Thermothielavioides terrestris [sequence omitted]

SEQ ID NO: 14 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQEECEKPGAVVTSFHDQSLKLGTYSLVTLQMAGYVAADGNGPVQESETAPSARWNQVVNAKNAPFQLQPDLNDNYVYMDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYEWFVDYYLDQMRLSSQVEGKRLLDVFDVHWYPEAMGGGERITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 15 - protein, 263 aa, Thermothielavioides terrestris
ASGSGQSTRYWDCCKPSCAWPGKAAVSQPVYSCDANFQRLSDFNVQSGCNGGSAYACADQTPWAVNDNLAYGFAATSIAGGSESSWCCACYALTFTSGPVAGKTMVVQSTSTGGDLGSNHFDIAMPGGGVGIFDGCSSQFGGLPGDRYGGISSRDQCDSFPAPLKPGCYWRFDWFQNADNPTVTFQQVQCPAEIVARSGCKRNDDSSFPVFTPPPPPPPPGPPPPGCTTQKWGQCGGIGYTGCTNCVAGTTCTQLNPWYHQCR

SEQ ID NO: 16 - protein, 263 aa, Thermothielavioides terrestris
ASGSGQSTRYWDCCKPSCAWPGKAAVSQPVYSCDANFQRLSDFNVQSGCNGGSAYACADQTPWAVNDNLAYGFAATSIAGGSESSWCCACYALTFTSGPVAGKTMVVQSTSTGGDLGSNHFDIAMPGGGVGIFDGCSSQFGGLPGDRYGGISSRDQCDSFPAPLKPGCYWRFDWFQNADNPTVTFQQVQCPAEIVARSGCKRNDDSSFPVFTPPPPPGPPPPPPPGCTTQKWGQCGGIGYTGCTNCVAGTTCTQLNPWYHQCR

SEQ ID NO: 17 - protein, 281 aa, Acremonium thermophilum
LDGKSTRYWDCCKPSCGWAGKAPVNQPVFSCSADWQRISDFNAKSGCDGGNAYSCADQTPWAVNEQFSYGFAATAISGGSEQSWCCACYALTFNSGPVAGKTMVVQSTSTGGDLGENHFDLAIPGGGVGIFNGCQSQFGGLPGAQYGGIQDRSQCSSFPAPLQPGCYWRFDWFQNADNPTFTFQRVQCPSELTSRTGCKRDDDANYPVFSPPSGRPSGSSPPGGSPPGTTTTRRPATTTGSSPTPTQSHYGQCGGIGYSGPTVCASGTTCQVLNPYYSQCL

SEQ ID NO: 18 - protein, 551 aa, Paenibacillus polymyxa
MKKPLGKIVASTALLISVAFSSSIASAVVHGQTAKTITIKVDTFKDRKPISPYIYGTNQDLAGDENMAARRLGGNRMTGYNWENNMSNAGSDWQHSSDNYLCSNGGLTQAECEKPGAVVTSFHDQSLKLGTYSLVTLPMAGYVAADGNGSVQESEAAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 19 - protein, 293 aa, Neurospora tetrasperma
MRSSTVLQTGLVAALPFAVQAASGSGQSTRYWDCCKPSCSWSGKASVNRPVLACDANNNPLSDASVKSGCDGGSAYTCANNSPWAVNDQLSYGFAATKLSGGTESSWCCACYALTFTSGPVAGKTMVVQSTSTGGDLGSNHFDINMPGGGVGLFDGCTRQFGGLPGAQYGGISSRSQCDSFPAALKPGCQWRFDWFQNADNPNFTFKQVQCPSELTSRTGCKRNDDSQFPVFTPPSGGGTNPSTPTTPPSSGGGSGCTADKYAQCGGSGWSGCTNCPSGSTCKTINDYYHQCA

SEQ ID NO: 20 - protein, 316 aa, Staphylotrichum coccosporum
MRSSPVLRTALAAALPLAALAADGKSTRYWDCCKPSCSWPGKASVNQPVFACSANFQRISDPNVKSGCDGGSAYACADQTPWAVNDNFSYGFAATSISGGNEASWCCGCYELTFTSGPVAGKTMVVQSTSTGGDLGTNHFDLAMPGGGVGIFDGCSPQFGGLAGDRYGGVSSRSQCDSFPAALKPGCYWRFDWFKNADNPTFTFRQVQCPSELVARTGCRRNDDGNFPVFTPPSGGQSSSSSSSSSAKPTSTSTSTTSTKATSTTSTASSQTSSSTGGGCAAQRWAQCGGIGFSGCTTCVSGTTCNKQNDWYSQCL

SEQ ID NO: 21 - protein, 435 aa, Humicola insolens
MARGTALLGLTALLLGLVNGQKPGETKEVHPQLTTFRCTKRGGCKPATNFIVLDSLSHPIHRAEGLGPGGCGDWGNPPPKDVCPDVESCAKNCIMEGIPDYSQYGVTTNGTSLRLQHILPDGRVPSPRVYLLDKTKRRYEMLHLTGFEFTFDVDATKLPCGMNSALYLSEMHPTGAKSKYNPGGAYYGTGYCDAQCFVTPFINGLGNIEGKGSCCNEMDIWEANSRASHVAPHTCNKKGLYLCEGEECAFEGVCDKNGCGWNNYRVNVTDYYGRGEEFKVNTLKPFTVVTQFLANRRGKLEKIHRFYVQDGKVIESFYTNKEGVPYTNMIDDEFCEATGSRKYMELGATQGMGEALTRGMVLAMSIWWDQGGNMEWLDHGEAGPCAKGEGAPSNIVQVEPFPEVTYTNLRWGEIGSTYQEVQKPKPKPGHGPRSD

SEQ ID NO: 22 - protein, 524 aa, Paenibacillus polymyxa
VVHGQTAKTITIKVDTFKDRKPISPYIYGTNQDLAGDENMAARRLGGNRMTGYNWENNMSNAGSDWQQSSDNYLCSNGGLTQAECEKPGAVTTSFHDQSLKLGTYSLVTLPMAGYVAKDGNGSVQESEKAPSARWNQVVNAKNAPFQLQPDLNDNRVYVDEFVHFLVNKYGTASTKAGVKGYALDNEPALWSHTHPRIHGEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWNSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 23 - protein, 294 aa, Chaetomium thermophilum
ADGKSTRYWDCCKPSCSWPGKAAVSQPVFACDRNFNRLSDFNVQSGCNGGPAYSCADQTPWAVNDQFSYGFAATNIAGGNEASWCCACYKLTFTSGPVAGSKVMVVQSTSTGGDLGNNHFDLNIPGGGVGIFDGCTPQFGGLPGERYGGISSRSQCDSFPDALKPGCYWRFDWFLNADNPNFTFERVQCPSELVARTGCKRNDDGNYPVFTPPSGDSPSSSSAAPTSTSTSQQPQQPTSSSSQASVPTSNPGGCTSQKWAQCGGIGFTGCTTCVSGTTCTKLNDWYSQCTMINL

(19) United States
(12) Patent Application Publication
(10) Pub. No.: US 2026/0337526 A1
(43) Pub. Date: Oct. 29, 2026

(54) USE OF ENZYME FOR REPLACING WHITENESS-MAINTAINING AGENT IN A CLEANING COMPOSITION

(71) Applicant: NOVOZYMES A/S, Bagsvaerd (DK)

(72) Inventors: Chaoyang YU, Beijing (CN); lasminy Da Silva BRASIL, Bagsvaerd (DK); Mirko IUBATTI, Bagsvaerd (DK)

(73) Assignee: NOVOZYMES A/S, Bagsvaerd (DK)

(21) Appl. No.: 19/113,401

(22) PCT Filed: Sep. 21, 2023
(86) PCT No.: PCT/CN2023/120395

§ 371 Date: Mar. 19, 2025

(30) Foreign Application Priority Data
Sep. 21, 2022 (WO) PCT/CN2022/120202

(51) Int. Cl. C11D 3/386; C11D 3/37; C11D 3/42

(52) U.S. Cl. CPC C11D 3/38645; C11D 3/37; C11D 3/38636; C11D 3/42; C11D 2111/12; C12Y 302/01004; C12Y 304/00

(57) ABSTRACT

Disclosed is the use of an enzyme for replacement of a whiteness-maintaining agent in a cleaning composition, wherein the enzyme is selected from the group consisting of a protease, a mannanase, a cellulase, and combinations thereof.

### REFERENCE TO A SEQUENCE LISTING

This application contains a Sequence Listing in computer readable form, which is incorporated herein by reference.

### FIELD OF INVENTION

This invention relates to use of an enzyme for replacement of a whiteness/color maintaining component (e.g., an optical brightener) in a cleaning composition, wherein the enzyme is selected from the group consisting of a protease, a mannanase, a cellulase and combinations thereof.

### BACKGROUND OF INVENTION

Textiles e.g., clothes, become dingy after worn and/washed. One reason is due to the whiteness/color loss of the textiles during wash process. To maintain the whiteness/color of textiles, whiteness-maintaining agent such as optical brighteners and anti-redeposition polymers are often added to laundry detergents. However, these chemical ingredients may bring health or environmental concerns for being unsustainable because they are from a non-renewable source. It is thus desirable to provide alternative detergents that have an improved sustainability profile while keeping or even improving the key performance (e.g., whiteness/color-maintaining effect) of the detergents.

### SUMMARY OF INVENTION

The present inventor has surprisingly found that some enzymes can substitute significant amounts of the whiteness/color maintaining agent (e.g., optical brighteners and/or anti-redeposition polymers) of a detergent composition without impairing the overall whiteness/color maintenance performance. The inventor has found that the whiteness/color of the treated textiles may even be improved by this substitution.

In one aspect, the invention concerns use of an enzyme for replacement of a whiteness-maintaining agent in a cleaning composition, wherein the enzyme is selected from the group consisting of a protease, a mannanase, a cellulase and combinations thereof, preferably the enzyme is a combination of two or three enzymes selected from a protease, a mannanase and a cellulase.

In another aspect, the present invention relates to a cleaning composition free of at least one whiteness-maintaining agent, wherein the composition comprises an enzyme selected from the group consisting of a protease, a mannanase, a cellulase and combinations thereof, wherein the whiteness-maintaining agent is selected from the group consisting of an optical brightener, an anti-redeposition polymer and mixture thereof. The cleaning composition provided by the present invention has improved sustainability profile because at least one whiteness-maintaining agent can be replaced by eco-friendly enzymes while keeping or even improving the key performance (e.g., whiteness/color-maintaining effect) of the composition.

In a further aspect, the invention relates to a method for maintaining or improving the whiteness and/or color of a textile, comprising: (a) exposing said textile to a wash liquor comprising the detergent composition of the invention; and optionally (b) rinsing the textile.

### DEFINITIONS

As used herein, the singular forms “a”, “an”, and “the” are intended to include the plural forms as well, unless the context clearly indicates otherwise.

If not indicated otherwise, all references to percentages (%) in relation to the disclosed compositions relate to wt % relative to the total weight of the respective composition.

Unless defined otherwise or clearly indicated by context, all technical and scientific terms used herein have the same meaning as commonly understood by one of ordinary skill in the art to which this invention belongs.

Cleaning components: The term “cleaning components” is defined herein to mean the types of chemicals which can be used in cleaning compositions. Examples of cleaning components are alkalis, surfactants, solvents, hydrotropes, builders, co-builders, chelators or chelating agents, bleaching system or bleach components, polymers, foam boosters, suds suppressors, dispersants, dye transfer inhibitors, perfume, bactericides, fungicides, corrosion inhibitors, soil suspending agents, soil release polymers, whiteness/color-maintaining agents such as optical brighteners and anti-redeposition agents, enzyme inhibitors or stabilizers, enzyme activators, antioxidants, preservatives, solvents and solubilizers.

Whiteness/color-maintaining agents: The term “whiteness/color-maintaining agents” refers to additives used in a detergent that can help maintain the original whiteness/color of the fabric or prevent/delay the loss of whiteness/color, via e.g., preventing soil (e.g., soluble soil, and insoluble soil such as clay particles and tiny fibers) from resettling on a fabric after it has been removed during washing, or by disguising/masking the loss of whiteness/color so as to make a textile appear whiter and brighter. These agents typically include but not limited to optical brighteners and anti-redeposition agents as set forth below. In the present invention, the term “whiteness/color-maintaining agents” may be used interchangeably with the term “whiteness-maintaining agents”.

Optical brighteners: The term optical brighteners as used herein is used interchangeably with the terms optical brightening agents, fluorescent brightening agents or fluorescent whitening agents. These additives are often used to enhance the appearance of color and/or brightness of a material such as a textile and paper, making materials look less yellow/less dingy, and thus to maintain the original whiteness and color of a material for a longer period of time.

Anti-redeposition agents: The term “anti-redeposition agents” in the context of the present invention refers to additives used in a detergent to help prevent soil from resettling on a fabric after it has been removed during washing. Suitable anti-redeposition agents may include but are not limited to anti-redeposition polymers such as polyacrylic acid, a modified polyacrylic acid polymer, a modified polyacrylic acid copolymer, a maleic acid-acrylic acid copolymer, carboxymethylcellulose (CMC), cellulose gum, methyl cellulose, polyvinyl alcohol (PVA), polyvinylpyrrolidone (PVP), polyoxyethylene and/or polyethyleneglycol (PEG), homopolymers of acrylic acid, copolymers of acrylic acid and maleic acid, ethoxylated polyethyleneimines, and/or combinations thereof. The cellulose-based polymers described under soil release polymers below may also function as anti-redeposition agents.

Cleaning composition: The term “cleaning composition (may also be referred as “detergent composition”) refers to compositions that find use in the removal of undesired compounds from items to be cleaned. The cleaning composition may be used to e.g., for household cleaning and industrial cleaning. The terms encompass any materials/compounds selected for the particular type of cleaning composition desired and the form of the product (e.g., liquid, gel, powder, granulate, paste, or spray compositions). In addition to containing an enzyme of the present invention, the cleaning composition of the present invention may contain one or more additional enzymes (such as lipases, amylases, hemicellulases, peroxidases, xylanases, phospholipases, esterases, cutinases, keratinases, reductases, oxidases, phenoloxidases, lipoxygenases, ligninases, pullulanases, malanases, β-glucanases, arabinosidases, hyaluronidase, laccase, deoxyribonucleases (DNases), hexosaminidases, and any mixture thereof), and/or one or more cleaning components as described above.

Mature polypeptide: The term “mature polypeptide” means a polypeptide in its final form following translation and any post-translational modifications, such as N-terminal processing, C-terminal truncation, glycosylation, phosphorylation, etc.

It is known in the art that a host cell may produce a mixture of two of more different mature polypeptides (i.e., with a different C-terminal and/or N-terminal amino acid) expressed by the same polynucleotide. It is also known in the art that different host cells process polypeptides differently, and thus, one host cell expressing a polynucleotide may produce a different mature polypeptide (e.g., having a different C-terminal and/or N-terminal amino acid) as compared to another host cell expressing the same polynucleotide.

Sequence identity: The relatedness between two amino acid sequences or between two nucleotide sequences is described by the parameter “sequence identity”.

For purposes of the present invention, the sequence identity between two amino acid sequences is determined as the output of “longest identity” using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 6.6.0 or later. The parameters used are a gap open penalty of 10, a gap extension penalty of 0.5, and the EBLOSUM62 (EMBOSS version of BLOSUM62) substitution matrix. In order for the Needle program to report the longest identity, the nobrief option must be specified in the command line. The output of Needle labeled “longest identity” is calculated as follows:

(Identical Residues×100)/(Length of Alignment−Total Number of Gaps in Alignment)

Variant: The term “variant” means a polypeptide/enzyme having the same type of activity as the parent enzyme and comprising an alteration, i.e., a substitution, insertion, and/or deletion, at one or more positions compared to the amino acid sequence of the parent. A substitution means replacement of the amino acid occupying a position with a different amino acid; a deletion means removal of the amino acid occupying a position; and an insertion means adding an amino acid adjacent to and immediately following the amino acid occupying a position.

In the context of the present invention, a variant may e.g. be a variant of an identified protease that has the enzymatic activity of the parent.

Variant nomenclature: In describing enzyme variants herein, the nomenclature described below is adapted for ease of reference. The accepted IUPAC single letter amino acid abbreviation is generally employed.

Substitutions: For an amino acid substitution, the following nomenclature is used: Original amino acid, position, substituted amino acid. Accordingly, the substitution of threonine at position 226 with alanine is designated as “T226A”. Multiple mutations may be separated by addition marks (“+”), e.g., “G205R+S411F”, or by a comma, e.g., “G205R, S411F”, representing substitutions at positions 205 and 411 of glycine (G) with arginine (R) and serine(S) with phenylalanine (F), respectively.

Deletions: For an amino acid deletion, the following nomenclature is used: Original amino acid, position, *. Accordingly, the deletion of glycine at position 195 is designated as “G195*”. Insertions: For an amino acid insertion, the following nomenclature is used: Original amino acid, position, original amino acid, inserted amino acid. Accordingly, the insertion of lysine after glycine at position 195 is designated “G195GK”. An indication of an insertion at a particular position is understood as being an insertion after the original amino acid residue. For example, an “insertion at position 195” is understood to be an insertion after the original residue in position 195.

Multiple alterations: Variants comprising multiple alterations are separated by addition marks (“+”) or commas, e.g., “R170Y+G195E” or “R170Y,G195E” representing a substitution of arginine and glycine at positions 170 and 195 with tyrosine and glutamic acid, respectively.

Different alterations: Where different alterations can be introduced at a position, the different alterations may be separated by a comma, e.g., “R170Y,E” represents a substitution of arginine at position 170 with tyrosine or glutamic acid. Thus, “Y167G,A+R170G,A” designates the following variants: “Y167G+R170G”, “Y167G+R170A”, “Y167A+R170G”, and “Y167A+R170A”.

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, ramie, cellulose acetate fibers (tricell), lyocell or blends thereof. The textile or fabric may also be non-cellulose based such as natural polyamides including wool, camel, cashmere, mohair, rabit and silk or synthetic polymer such as nylon, aramid, polyester, acrylic, polypropylen and spandex/elastane, or blends thereof as well as blend of cellulose based and non-cellulose based fibers. Examples of blends are blends of cotton and/or rayon/viscose with one or more companion material such as wool, synthetic fibers (e.g. polyamide fibers, acrylic fibers, polyester fibers, polyvinyl alcohol fibers, polyvinyl chloride fibers, polyurethane fibers, polyurea fibers, aramid fibers), and cellulose-containing fibers (e.g. rayon/viscose, ramie, flax/linen, jute, cellulose acetate fibers, lyocell). Fabric may be conventional washable laundry, for example, stained household laundry. When the term fabric or garment is used it is intended to include the broader term textiles as well.

Whiteness/color-maintaining performance: The term is defined herein as a broad term with different meanings in different regions and for different consumers. Loss of whiteness/color of a fabric can e.g., be due to greying, yellowing, or removal of optical brighteners/hueing agents. Greying and yellowing can be due to soil redeposition, body soils, colouring or dye transfer. In the present invention, the term “whiteness/color-maintaining performance” may be used interchangeably with the term “Whiteness-maintaining effect” or “whiteness performance”. For the purpose of the present invention, the whiteness/color maintaining performance can be measured as ΔR460 value as described in the Example section.

### BRIEF DESCRIPTION OF THE DRAWINGS

A more complete understanding of the present invention may be derived by referring to the detailed description and claims when considered in connection with the Figures.

FIG. 1 shows the pictures of the washed CN-42 cotton textile by detergent (with or without whiteness-maintaining agent) in the presence or absence of the enzymes of the present invention, wherein,

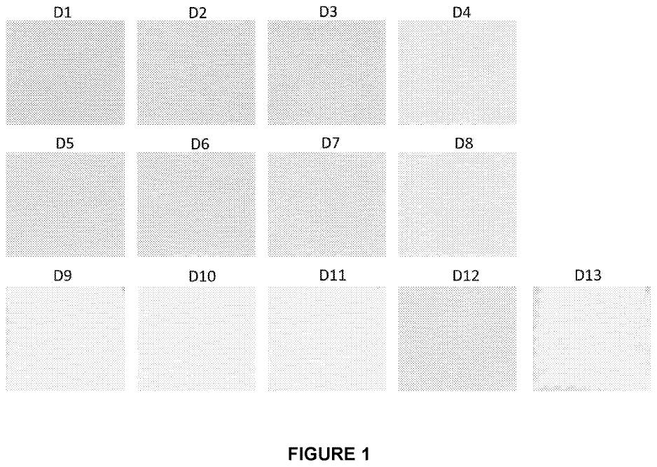

Row 1, from left to right:
D1: textile washed by model detergent 1;
D2: textile washed by model detergent 1+optical brightener (OB);
D3: textile washed by model detergent 1+optical brightener (OB)+anti-redeposition polymer;
D4: textile washed by model detergent 1+ cellulase B;

Row 2, from left to right:
D5: textile washed by model detergent 1+ cellulase A;
D6: textile washed by model detergent 1+protease;
D7: textile washed by model detergent 1+mannanase;
D8: textile washed by model detergent 1+ cellulase B+protease;

Row 3, from left to right:
D9: textile washed by model detergent 1+ cellulase B+mannanase;
D10: textile washed by model detergent 1+ cellulase B+protease+mannanase;
D11: textile washed by model detergent 1+ cellulase A+protease+mannanase;
D12: textile washed by model detergent 1+ cellulase A+protease;
D13: textile washed by model detergent 1+ cellulase A+mannanase.

### DETAILED DESCRIPTION OF THE INVENTION

The inventor has found that the reduction in the obtained R460-value of textiles treated with a detergent composition free of whiteness/color-maintaining agents (e.g., optical brighter/anti-redeposition polymers) may be fully compensated by addition of enzyme(s) of the invention.

Therefore, one aspect of the present invention concerns use of an enzyme for replacement of a whiteness/color-maintaining agent in a cleaning composition, wherein the enzyme is selected from the group consisting of a protease, a mannanase, a cellulase and combinations thereof. By inclusion of said enzyme(s), the amount of a whiteness/color-maintaining agent can be reduced by at least 20%, e.g., by at least 30%, by at least 40%, by at least 50% or even 100%.

Accordingly, in one embodiment of the invention, the amount of optical brightener is reduced by at least 30%, by at least 40%, by at least 50%, by at least 60%, by at least 70%, by at least 75%, by at least 80% or by at least 90%.

In one embodiment of the invention, the amount of anti-redeposition polymer is reduced by at least 30%, by at least 40%, by at least 50%, by at least 60%, by at least 70%, by at least 75%, by at least 80% or by at least 90%.

In one embodiment, both the optical brightener and the anti-redeposition polymer in a detergent composition are fully replaced by said enzyme(s).

Another aspect of the invention concerns a method for maintaining and/or improving the whiteness/color of a textile, wherein the textile is exposed to a wash liquid with a detergent comprising an enzyme selected from the group consisting of a protease, a mannanase, a cellulase and combinations thereof. In one embodiment, said enzyme is a combination of a protease and a mannanase. In another embodiment, said enzyme is a combination of a protease and a cellulase. In yet another embodiment, said enzyme is a combination of a protease, a mannanase and a cellulase.

Suitable amount of the enzyme(s) of the present invention may be present in the range of 0.0001 wt % to 3 wt % based on the total weight of the cleaning composition, such as in the range of 0.0003 wt % to 2 wt %, 0.005 wt % to 1 wt %, 0.05 wt % to 1.5 wt % or 0.1 wt % to 0.5 wt %, based on the total weight of the cleaning composition.

In another embodiment, the amount of the enzyme(s) of the invention is in the range of 0.0001 mg to 100 mg enzyme protein per liter of wash liquor, such as 0.01 mg to 50 mg enzyme protein, 0.1 mg to 30 mg enzyme protein, 0.2 mg to 10 mg enzyme protein or 1 mg to 5 mg enzyme protein, per liter of wash liquor.

In one embodiment of the invention, the optical brightener is selected from the group comprising benzenesulfonic acid, 2,2′-(1,2-ethenediyl)bis [5-[4-(4-morpholinyl)-6-(phenylamino)-1,3,5-triazin-2-yl]amino]-, disodium salt; 2,2′-([1,1′-biphenyl]-4,4′-diyldi-2, 1-ethenediyl)bis-, disodium salt; diaminostilbene-sulphonic acid derivative including sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4 (N-methyl-N-2-hydroxy-ethylamino)-s-triazin-6-ylamino) stilbene-2,2′-disulphonate, 4,4′-bis-(4-phenyl-2, 1,3-triazol-2-yl) stilbene-2,2′-disulphonate; 4,4′-bis-(2-anilino-4 (1-methyl-2-hydroxy-ethylamino)-s-triazin-6-ylamino) stilbene-2,2′-disulphonate and/or 2-(stilbyl-4″-naptho-1.,2′: 4,5)-1,2,3-trizole-2″-sulphonate; or 4,4′-bis-(2-morpholino-4 anilino-s-triazin-6-ylamino) stilbene disulphonate or 2,2′-bis-(phenyl-styryl)disulphonate, or 4.4′-bis-(sulfostyryl)-biphenyl disodium salt, bistriazinyl stilbene derivative, and mixtures hereof.

In one embodiment the optical brightener is 4.4′-bis-(sulfostyryl)-biphenyl disodium salt or bistriazinyl stilbene derivative.

In other embodiments of the invention preferred optical brighteners are Tinopal DMS or Tinopal CBS or Tinopal CBS-X available from BASF. Tinopal DMS is the disodium salt of 4,4′-bis-((2-morpholino-4 anilino-s-triazin-6-yl)amino) stilbene disulphonate. Tinopal CBS is the disodium salt of 2,2′-bis-(phenyl-styryl)disulphonate. Tinopal CBS-X is a 4.4′-bis-(sulfostyryl)-biphenyl disodium salt also known as Disodium Distyrylbiphenyl Disulfonate. Also preferred are the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

In one embodiment, the anti-redeposition polymer is selected from the group comprising (carboxymethyl) cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Suitable examples include PVP-K15, PVP-K30, ChromaBond S-400, ChromaBond S-403E and Chromabond S-100 from Ashland Aqualon, and Sokalan® HP 165, Sokalan® HP 50 (Dispersing agent), Sokalan® HP 53 (Dispersing agent), Sokalan® HP 59 (Dispersing agent), Sokalan® HP 56 (dye transfer inhibitor), Sokalan® HP 66 K (dye transfer inhibitor) from BASF. Further exemplary polymers include sulfonated polycarboxylates, polyethylene oxide and polypropylene oxide (PEO-PPO) and diquaternium ethoxy sulfate, ACUSOL™ 445N Detergent Polymer from DOW, and ethoxylated homopolymer Sokalan® HP 20 from BASF.

In one embodiment, the detergent composition comprising the enzyme(s) of the invention improves the whiteness of the textile, i.e., the ΔR460 value is at least 1.0, e.g., at least 2.0, 5.0, 8.0, 10.0, or at least 15.0, as compared to the detergent with optical brightener and/or anti-redeposition polymer but without said enzyme(s).

In one embodiment, in addition to the enzyme(s) of the invention, the detergent composition further comprises an enzyme selected from the group of amylases, lipases, hemicellulases, peroxidases, xylanases, phospholipases, esterases, cutinases, keratinases, reductases, oxidases, phenoloxidases, lipoxygenases, ligninases, pullulanases, β-glucanases, arabinosidases, hyaluronidase, laccase, deoxyribonucleases (DNases), hexosaminidases and, or any mixture thereof.

In one embodiment, the enzyme suitable for replacing a whiteness-maintaining agent is an enzyme having cellulase activity. Suitable cellulase may be selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45), preferably family GH45 cellulases. Suitable family GH44 cellulases can be a family 44 xyloglucanase having a sequence of at least 60% identity to positions 40-559 of SEQ ID NO: 2 of WO 2001/062903.

In one embodiment, the enzyme having cellulase activity is a polypeptide having at least 60% sequence identity to the polypeptide of SEQ ID NO: 13, 14, 15, 16, 17, 18, 19, 20, 21, 22 or 23. Preferably the enzyme having cellulase activity is a polypeptide having at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 13, 14, 15, 16, 17, 18, 19, 20, 21, 22 or 23, or a fragment thereof having cellulase activity.

In one embodiment, the enzyme having cellulase activity is a polypeptide having at least 80%, at least 85%, at least 90%, at least 95%, at least 98%, at least 99% or 100% sequence identity to the mature polypeptide of SEQ ID NO: 13, or a fragment thereof having cellulase activity. In a specific embodiment, said cellulase is from Thermothielavioides, preferably from Thermothielavioides terrestris.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 14, or a fragment thereof having cellulase activity. In one embodiment, the mature polypeptide is amino acids 22 to 294 of SEQ ID NO: 14. In a specific embodiment, said enzyme is from Paenibacillus, preferably from Paenibacillus polymyxa.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 15, or a fragment thereof having cellulase activity. In a specific embodiment, said enzyme is from Thermothielavioides, preferably from Thermothielavioides terrestris.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 16, or a fragment thereof having cellulase activity. In a specific embodiment, said enzyme is from Thermothielavioides, preferably from Thermothielavioides terrestris.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 17, or a fragment thereof having cellulase activity. In a specific embodiment, said enzyme is from Acremonium, preferably from Acremonium thermophilum.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 18, or a fragment thereof having cellulase activity. In a specific embodiment, said enzyme is from Paenibacillus, preferably from Paenibacillus polymyxa.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 19, or a fragment thereof having cellulase activity. In a specific embodiment, said enzyme is from Neurospora, preferably from Neurospora tetrasperma.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 20, or a fragment thereof having cellulase activity. In a specific embodiment, said enzyme is from Staphylotrichum, preferably from Staphylotrichum coccosporum.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 21, or a fragment thereof having cellulase activity. In a specific embodiment, said enzyme is from Humicola, preferably from Humicola insolens.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 22, or a fragment thereof having cellulase activity. In a specific embodiment, said enzyme is from Paenibacillus, preferably from Paenibacillus polymyxa.

In another embodiment, the enzyme having cellulase activity is a polypeptide having at least 80%, at least 85%, at least 90%, at least 95%, at least 98%, at least 99% or 100% sequence identity to the mature polypeptide of SEQ ID NO: 23, or a fragment thereof having cellulase activity. In a specific embodiment, said enzyme is from Chaetomium, preferably from Chaetomium thermophilum.

Additional suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307 and WO99/001544.

Commercially available cellulases include Celluzyme, Carezyme, Carezyme Elite, Carezyme Premium, Luminous, Celluclean, Celluclean Classic, Cellusoft, Whitezyme, Celluclean 4500T and Celluclean 5000L (all registered trademarks of Novozymes A/S), Clazinase and Puradax HA (registered trademarks of Genencor International Inc.), KAC-500 (B) (registered trademark of Kao Corporation), and Revitalenz 2000 (registered trademarks of Danisco/Dupont), and Biotouch FLX1, Biotouch FCL75, Biotouch DCL and Biotouch FCC45 (registered trademarks of AB Enzymes), and Lavergy C Bright from BASF.

The preparation of the enzyme having cellulase activity as described herein can e.g., be performed as described in WO 2015/036579 (incorporated herein by reference). The enzyme of the present invention may also be prepared by any method known in the art.

In the present invention, the polypeptide having mannanase activity or the mannanase suitable for replacing a whiteness/color-maintaining agent is an enzyme that hydrolyses compounds known as mannans. Mannanases are enzymes catalyzing hydrolyses of 1,4-beta-D-mannosidic linkages in mannans, galactomannans, glucomannans, and galactoglucomannans. Mannans are polysaccharides with a backbone of b-1,4-linked D-mannopyranosyl residues, which can contain galactose or acetyl substitutions and may have glucose residues in the backbone. The main enzyme type participating in the degradation of mannans are endo-1,4-p-mannanases (EC 3.2.1.78), which hydrolyze the internal glycoside bonds in the mannan backbone. For purposes of the present invention, mannanase activity is determined according to the procedure described in the Assay II. According to CAZy (www.cazy.org), endo-1,4-p-mannanases can be found in glycoside hydrolase families 5, 26 and 113. Suitable mannanases include those of bacterial or fungal origin. Chemically or genetically modified mannanases are included. It may be a wild-type from Bacillus or Humicola, particularly B. agaradhaerens, B. licheniformis, B. halodurans, B. clausii, or H. insolens. Suitable mannanases are described in WO 1999/064619. Commercially available mannanases are Mannaway (Novozymes A/S), EFFECTENZ™ M1000 and Preferenz M 100 from Dupont, Purabrite® (Danisco/DuPont), and Biotouch M9 from AB Enzyme.

Other preferred mannanases include any of the GH26 Mannanases, mannanase from Preussia aemulans mature sequence of SEQ ID NO: 2 of WO2017/021515, mannanase from Yunnania penicillata mature sequence of SEQ ID NO: 2 of WO2017/021516, mannanase from Myrothecium roridum mature sequence of SEQ ID NO: 2 of WO2017/021517, mannanase from Chaetomium brasiliense mature sequence of SEQ ID NO: 2 of WO2017/021518, mannanases from Ascobolus stictoideus or mannanase from Chaetomium virescens SEQ ID NO: 3 and 6 from WO2015/040159.

In one embodiment, the enzyme having mannanase activity or the mannanase is a polypeptide having at least 60% sequence identity to the polypeptide of SEQ ID NO: 6, 7, 8, 9, 10, 11 or 12. Preferably the enzyme having mannanase activity is a polypeptide having at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 6, 7, 8, 9, 10, 11 or 12, or a fragment thereof having mannanase activity.

In one embodiment, the enzyme having mannanase activity is a polypeptide having at least 80%, at least 85%, at least 90%, at least 95%, at least 98%, at least 99% or 100% sequence identity to the mature polypeptide of SEQ ID NO: 6, or a fragment thereof having mannanase activity. In a specific embodiment, said mannanase is from Alkalihalobacillus, preferably from Alkalihalobacillus bogoriensis.

In one embodiment, the enzyme having mannanase activity is a polypeptide having at least 80%, at least 85%, at least 90%, at least 95%, at least 98%, at least 99% or 100% sequence identity to the mature polypeptide of SEQ ID NO: 7, or a fragment thereof having mannanase activity. In a specific embodiment, said mannanase is from Alkalihalobacillus, preferably from Alkalihalobacillus bogoriensis.

In one embodiment, the enzyme having mannanase activity is a polypeptide having at least 80%, at least 85%, at least 90%, at least 95%, at least 98%, at least 99% or 100% sequence identity to the mature polypeptide of SEQ ID NO: 8, or a fragment thereof having mannanase activity.

In one embodiment, the enzyme having mannanase activity is a polypeptide having at least 80%, at least 85%, at least 90%, at least 95%, at least 98%, at least 99% or 100% sequence identity to the mature polypeptide of SEQ ID NO: 9, or a fragment thereof having mannanase activity.

In one embodiment, the enzyme having mannanase activity is a polypeptide having at least 80%, at least 85%, at least 90%, at least 95%, at least 98%, at least 99% or 100% sequence identity to the mature polypeptide of SEQ ID NO: 10, or a fragment thereof having mannanase activity. In a specific embodiment, said mannanase is from Bacillus, preferably from Bacillus clausii.

In one embodiment, the enzyme having mannanase activity is a polypeptide having at least 80%, at least 85%, at least 90%, at least 95%, at least 98%, at least 99% or 100% sequence identity to the mature polypeptide of SEQ ID NO: 11, or a fragment thereof having mannanase activity. In a specific embodiment, said mannanase is from Bacillus sp.

In one embodiment, the enzyme having mannanase activity is a polypeptide having at least 80%, at least 85%, at least 90%, at least 95%, at least 98%, at least 99% or 100% sequence identity to the mature polypeptide of SEQ ID NO: 12, or a fragment thereof having mannanase activity. In a specific embodiment, said mannanase is from Paenibacillus sp.

Proteases suitable for replacing a whiteness/color-maintaining agent may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g., from the M4 family, or another metalloprotease such as those from the M5, M7 or M8 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a covalent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus and related genera (cf. Patel and Gupta, supra). Examples of Bacillus species from which subtilases have been derived include Bacillus lentus, Bacillus alcalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN′, subtilisin 309, subtilisin 147 and subtilisin 168 and e.g. protease PD138 (described in WO 93/18140). Other useful proteases are e.g. those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g. the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234. Preferred protease variants may, for example, comprise one or more of the mutations selected from the group consisting of: S3T, V41, S9R, S9E, A15T, S24G, S24R, K27R, N42R, S55P, G59E, G59D, N60D, N60E, V66A, N74D, S85R, A96S, S97G, S97D, S97A, S97SD, S99E, S99D, S99G, S99M, S99N, S99R, S99H, S101A, V1021, V102Y, V102N, S104A, G116V, G116R, H118D, H118N, A120S, S126L, P127Q, S128A, S154D, A156E, G157D, G157P, S158E, Y161A, R164S, Q176E, N179E, S182E, Q185N, A188P, G189E, V193M, N198D, V1991, Q200L, Y203W, S206G, L211Q, L211D, N212D, N212S, M216S, A226V, K229L, Q230H, Q239R, N246K, S253D, N255W, N255D, N255E, L256E, L256D T268A and R269H, wherein position numbers correspond to positions of the Bacillus lentus protease shown in SEQ ID NO: 1 of WO 2016/001449. Protease variants having one or more of these mutations are preferably variants of the Bacillus lentus protease (Savinase®, also known as subtilisin 309) shown in SEQ ID NO: 1 of WO 2016/001449 or of the Bacillus amyloliquefaciens protease (BPN′) shown in SEQ ID NO: 2 of WO 2016/001449. Such protease variants preferably have at least 80% sequence identity to SEQ ID NO: 1 or to SEQ ID NO: 2 of WO 2016/001449.

Another protease of interest is the alkaline protease from Bacillus lentus DSM 5483, as described for example in WO 91/02792, and variants thereof which are described for example in WO 92/21760, WO 95/23221, EP 1921147, EP 1921148 and WO 2016/096711.

The protease may alternatively be a variant of the TY145 protease having SEQ ID NO: 1 of WO 2004/067737, for example a variant comprising a substitution at one or more positions corresponding to positions 27, 109, 111, 171, 173, 174, 175, 180, 182, 184, 198, 199 and 297 of SEQ ID NO: 1 of WO 2004/067737, wherein said protease variant has a sequence identity of at least 75% but less than 100% to SEQ ID NO: 1 of WO 2004/067737.

In some embodiments of the present invention, a preferred protease according to the present invention may be a protease having at least 60%, such as at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the polypeptide of SEQ ID NO: 1, 2, 3, 4 or 5.

In another embodiment, a preferred protease according to the present invention may be a variant of the polypeptide of SEQ ID NO: 2 comprising an alteration at one or more positions corresponding to positions 3, 4, 9, 15, 43, 68, 76, 99, 101, 103, 104, 160, 167, 170, 194, 199, 205, 206, 209, 217, 218, 222, 245, 261 and 262, wherein position numbers correspond to the positions of SEQ ID NO: 1, wherein each alteration is independently a substitution, deletion or insertion, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to the polypeptide of SEQ ID NO: 2.

In one embodiment, the protease of the invention is a variant of the polypeptide of SEQ ID NO: 2, comprising one or more substitutions selected from the group consisting of: S3T, V41, S9E, S9R, A15T, V68A, N76D, S99D, S99G, S99A, S99SE, S101E, S101N, S101R, S103A, V1041, G160S, Y167A, R170S, A194P, V199M, V2051, Q206L, Y209W, L217D, L217Q, N218D, M222S, Q245R, N261W and L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, at least 99%, but less than 100% sequence identity to SEQ ID NO: 2.

In one embodiment, the protease of the invention is a variant of the polypeptide of SEQ ID NO: 2, comprising one or more substitutions selected from the group consisting of: S3T, V41, S9E, S9R, A15T, V68A, N76D, S99D, S99G, S99A, S99SE, S101E, S101N, S101R, S103A, V104I, G160S, Y167A, R170S, A194P, V199M, V2051, Q206L, Y209W, L217D, L217Q, N218D, M222S, Q245R, N261W and L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, at least 99%, but less than 100% sequence identity to SEQ ID NO: 2.

In one embodiment, the protease of the invention is a variant of the polypeptide of SEQ ID NO: 2, comprising the substitution S87N, wherein the variant has protease activity and wherein the position corresponds to the position of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant of the polypeptide of SEQ ID NO: 2, comprising the substitutions Y167A+R170S+A194P, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant of the polypeptide of SEQ ID NO: 2, comprising the substitutions S9E+N43R+N76D+V2051+Q206L+Y209W+S259D+N261W+L262E, wherein position numbers correspond to the positions of SEQ ID NO: 1, and wherein the variant has protease activity and has at least 80, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant of the polypeptide of SEQ ID NO: 2, comprising the substitutions S3T+N43R+N76D+S87N+G118M+S128Q+N184E+V2051+Q206L+Y209W+S259D+N261W+L262E, wherein position numbers correspond to the positions of SEQ ID NO: 1, and wherein the variant has protease activity and has at least 80, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant of the polypeptide of SEQ ID NO: 4, comprising the substitutions A68S+T77N+T78|+G127S+A128P+G165Q+N184Q+A202V+N217S+S258P, wherein position numbers correspond to the positions of SEQ ID NO: 4, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 4.

In one embodiment, the protease of the invention is a variant comprising a substitution at one or more positions corresponding to positions 171, 173, 175, 179 or 180 of SEQ ID NO: 1 of WO2004/067737, wherein the variant has protease activity and has a sequence identity of at least 80%, at least 85%, at least 90%, at least 91%, at least 92%, at least 93%, at least 94%, at least 95%, at least 96%, at least 97%, at least 98%, or at least 99%, but less than 100% to SEQ ID NO: 1 of WO2004/067737.

In one embodiment, the protease of the invention is a variant comprising one or more substitutions compared to a parent protease, selected from the group consisting of X3V, X9 [E,R], X22 [R,A], X43R, X61 [E,D], X62 [E,D], X76 [D], X87N, X101 [E,G,D,N,M], X103A, X1041, X118 [V,R], X120V, X128 [A,L,S], X129Q, X130A, X160D, X185 [E,D], 188 [E,D], X191N, X194P, X2051, X206L, X209W, X216V, X217 [Q,D,E], X218 [D,E,S], X232V, X245R, X248D, X256 [E,D], X259 [E,D], X261 [E,D,W] and X262 [E,D], wherein position numbers correspond to the positions of BPN′ (SEQ ID NO: 1), wherein “X” represents any amino acid residue present in the specified position in the parent protease, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or SEQ ID NO: 2.

In one embodiment, the protease of the invention is a variant comprising any of the following substitution sets compared to a parent protease, wherein the parent protease has the amino acid sequence of SEQ ID NO: 1 or SEQ ID NO: 2 or has at least 80% sequence identity to SEQ ID NO: 1 or SEQ ID NO: 2, wherein position numbers correspond to the positions of BPN′ (SEQ ID NO: 1), wherein “X” represents any amino acid residue present in the specified position in the parent protease, and wherein the substitution set is selected from the group consisting of:
i. X9R+X15T+X68A+X218D+X245R,
ii. X9R+X15T+X68A+X245R,
iii. X61E+X194P+X2051+X261D,
iv. X61D+X2051+X245R,
v. X61E+X194P+X2051+X261D,
vi. X87N+X118V+X128L+X129Q+X130A,
vii. X87N+X101M+X118V+X128L+X129Q+X130A,
viii. X76D+X87R+X118R+X128L+X129Q+X130A,
ix. X22A+X62D+X101G+X188D+X232V+X245R,
x. X103A+X1041,
xi. X22R+X101G+X232V+X245R,
xii. X103A+X1041+X156D,
xiii. X103A+X1041+X261E,
xiv. X62D+X245R,
xv. X101N+X128A+X217Q,
xvi. X101E+X217Q,
xvii. X101E+X217D,
xviii. X9E+X43R+X262E,
xix. X76D+X43R+X209W,
xx. X2051+X206L+X209W,
xxi. X185E+X188E+X2051,
xxii. X256D+X261W+X262E,
xxiii. X191N+X209W,
xxiv. X261E+X262E,
xxv. X261E+X262D, and
xxvi. X167A+X170S+X194P,

wherein the protease variant has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or 2.

In one embodiment, the protease variant of the invention comprises the amino acid sequence of SEQ ID NO: 2 with the substitutions Y167A+R170S+A194P, wherein the variant has protease activity and wherein the positions correspond to the positions of SEQ ID NO: 1.

In one embodiment, the protease variant of the invention comprises the amino acid sequence of SEQ ID NO: 2 with the substitutions S9E+N43R+N76D+V2051+Q206L+Y209W+S259D+N261W+L262E, wherein the variant has protease activity and wherein position numbers correspond to the positions of SEQ ID NO: 1.

In one embodiment, the protease of the invention is an enzyme having or consisting of the amino acid sequence of SEQ ID NO: 2, 3, 4 or 5.

Suitable commercially available protease enzymes may include those sold under the trade names Alcalase®, Duralase™, Durazym™, Relase®, Relase® Ultra, Savinase®, Savinase® Ultra, Primase™, Polarzyme®, Kannase®, Liquanase®, Liquanase® Ultra, Ovozyme®, Coronase®, Coronase® Ultra, Blaze®, Blaze® Pro, Blaze Evity® 100T, Blaze Evity® 125T, Blaze Evity® 150T, Blaze Evity® 200T, Neutrase®, Everlase®, Esperase®, Progress® Uno, Progress® In and Progress® Excel (Novozymes A/S), those sold under the tradename Maxatase™ Maxacal™, Maxapem®, Purafect® Ox, Purafect® OxP, Puramax®, FN2™, FN3™, FN4ex™ Excellase®, Excellenz™ P1000, Excellenz™ P1250, Eraser™, Preferenz® P100, Preferenz® P300, Purafect Prime, Preferenz P110™, Effectenz P1000™, Purafect®, Effectenz P1050™, Purafect® Ox, Effectenz™ P2000, Purafast™, Properase®, Opticlean™ and Optimase® (Danisco/DuPont), BLAP (sequence shown in FIG. 29 of U.S. Pat. No. 5,352,604) and variants hereof (Henkel A G), Puzhi 1.0L from Bestzyme and KAP (Bacillus alkalophilus subtilisin) from Kao.

In one aspect, the variants of the enzymes (proteases, mannanases and cellulases) according to the present invention comprise a substitution, deletion, and/or insertion at one or more positions. In one embodiment, the number of amino acid substitutions, deletions and/or insertions introduced into the mature polypeptide of e.g. SEQ ID NO: 2, 3, 5, 6, 10, or 11 is no more than 20, e.g., 1-15, such as 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/11e, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/11e, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a polypeptide can be identified according to procedures known in the art, such as site-directed mutagenesis or alanine-scanning mutagenesis (Cunningham and Wells, 1989, Science 244:1081-1085). In the latter technique, single alanine mutations are introduced at every residue in the molecule, and the resultant mutant molecules are tested for proteas activity, cellulase activity or mannanase activity to identify amino acid residues that are critical to the activity of the molecule. See also, Hilton et al., 1996, J. Biol. Chem. 271:4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255:306-312; Smith et al., 1992, J. Mol. Biol. 224:899-904; Wlodaver et al., 1992, FEBS Lett. 309:59-64. The identity of essential amino acids can also be inferred from an alignment with a related polypeptide.

In some other embodiments, the enzymes suitable for replacing a whiteness/color-maintaining agent of a detergent composition is an enzyme combination of the protease, the mannanase and/or the cellulase as described above.

In some other embodiments, the enzymes suitable for replacing a whiteness/color-maintaining agent is an enzyme combination of a protease and a mannanase, wherein the protease is a polypeptide comprising or consisting of SEQ ID NO: 2, wherein the mannanase is a polypeptide having or consisting of SEQ ID NO: 6, 7, 8, 9, 10 or 11. In a specific embodiment, the protease is the polypeptide of SEQ ID NO: 2 with the substitutions S9E+N43R+N76D+V2051+Q206L+Y209W+S259D+N261W+L262E, wherein position numbers are based on the numbering of SEQ ID NO: 1, and wherein the mannanase is a polypeptide having or consisting of SEQ ID NO: 6 or 7.

In some embodiments, the enzymes suitable for replacing the whiteness/color-maintaining agent is an enzyme combination of a protease and a cellulase, wherein the protease comprises or consisting of the polypeptide of SEQ ID NO: 2, wherein the cellulase is a polypeptide having or consisting of SEQ ID NO: 12, 13, 14, 15, 16, 17, 18, 19, 20, 21, 22 or 23. In a specific embodiment, the protease is the polypeptide of SEQ ID NO: 2 with the substitutions S9E+N43R+N76D+V2051+Q206L+Y209W+S259D+N261W+L262E, wherein position numbers are based on the numbering of SEQ ID NO: 1, and wherein the cellulase is a polypeptide having or consisting of SEQ ID NO: 18, 21 or 22.

In some embodiments, the enzymes suitable for replacing the whiteness/color-maintaining agent is an enzyme combination of a mannanase and a cellulase, wherein the mannanase is a polypeptide comprising or consisting of SEQ ID NO: 6, 7, 8, 9, 10 or 11, wherein the cellulase is a polypeptide comprising or consisting of SEQ ID NO: 12, 13, 14, 15, 16, 17, 18, 19, 20, 21, 22 or 23. In a specific embodiment, the mannanase is a polypeptide comprising or consisting of SEQ ID NO: 6 or 7, and wherein the cellulase is a polypeptide having or consisting of SEQ ID NO: 18, 21 or 22.

In some embodiments, the enzymes suitable for replacing a whiteness/color-maintaining agent is an enzyme combination of a protease, a mannanase and a cellulase, wherein the protease is a polypeptide comprising or consisting of SEQ ID NO: 2, wherein the mannanase is a polypeptide having or consisting of SEQ ID NO: 6, 7, 8, 9, 10 or 11 and wherein the cellulase is a polypeptide having or consisting of SEQ ID NO: 12, 13, 14, 15, 16, 17, 18, 19, 20, 21, 22 or 23. In a specific embodiment, the protease is the polypeptide of SEQ ID NO: 2 with the substitutions S9E+N43R+N76D+V2051+Q206L+Y209W+S259D+N261W+L262E, wherein position numbers are based on the numbering of SEQ ID NO: 1, and the mannanase is a polypeptide having or consisting of SEQ ID NO: 6 or 7, and the cellulase is a polypeptide having or consisting of SEQ ID NO: 18, 21 or 22. In further another embodiment, the protease is the polypeptide of SEQ ID NO: 2 and the mannanase is a polypeptide having or consisting of SEQ ID NO: 7, and the cellulase is a polypeptide having or consisting of SEQ ID NO: 18 or 21.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in, for example, WO92/19709 and WO92/19708.

In one embodiment of the invention the textile is selected from the group consisting of: cellulose based textiles and textiles which partly is made of cellulose-based textile. In one embodiment, the textile is cotton, or a mixture of cotton with other types of fabric, such as a mixture of at least 50% polyester and at least 20% cotton, or a mixture of at least 30% polyester and at least 40% cotton.

The optical brightener may be present at most 0.6% by weight of the composition, such as at most 0.4% by weight of the composition, at most 0.3% by weight of the composition, at most 0.25% by weight of the composition, at most 0.2% by weight of the composition, at most 0.15% by weight of the composition, at most 0.1% by weight of the composition, at most 0.08% by weight of the composition, at most 0.05% by weight of the composition, at most 0.04% by weight of the composition, at most 0.02% by weight of the composition or at most 0.01% by weight of the composition.

The anti-redeposition polymer may be present at most 1% by weight of the composition, such as at most 0.8% by weight of the composition, at most 0.6% by weight of the composition, at most 0.4% by weight of the composition, at most 0.2% by weight of the composition, at most 0.15% by weight of the composition, at most 0.1% by weight of the composition, at most 0.08% by weight of the composition, at most 0.05% by weight of the composition, at most 0.04% by weight of the composition.

### Surfactants

The detergent composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 0.1% to 60% by weight, such as about 1% to about 40%, or about 3% to about 20%, or about 3% to about 10%. The surfactant(s) is chosen based on the desired cleaning application, and includes any conventional surfactant(s) known in the art. Any surfactant known in the art for use in detergents may be utilized.

When included therein the detergent will usually contain from about 1% to about 40% by weight, such as from about 5% to about 30%, including from about 5% to about 15%, or from about 20% to about 25% of an anionic surfactant. Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

When included therein the detergent will usually contain from about 1% to about 40% by weight of a cationic surfactant. Non-limiting examples of cationic surfactants include alklydimethylehanolamine quat (ADMEAQ), cetyltrimethylammonium bromide (CTAB), dimethyldistearylammonium chloride (DSDMAC), and alkylbenzyldimethylammonium, and combinations thereof, Alkyl quaternary ammonium compounds, Alkoxylated quaternary ammonium (AQA).

When included therein the detergent will usually contain from about 0.2% to about 60% by weight of a non-ionic surfactant, for example from about 0.3 to about 40%, such as from about 0.5% to about 30%, in particular from about 1% to about 20%, from about 3% to about 10%, such as from about 3% to about 5%, or from about 8% to about 12%. Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamide (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

When included therein the detergent will usually contain from about 1% to about 40% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

When included therein the detergent will usually contain from about 1% to about 40% by weight of a zwitterionic surfactant. Non-limiting examples of zwitterionic surfactants include betaine, alkyldimethylbetaine, and sulfobetaine, and combinations thereof.

### Builders and Co-Builders

The detergent composition may contain about 0-65% by weight of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca²⁺ and Mg²⁺. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), disilicates, ethanolamines such as 2-aminoethan-1-ol (MEA), iminodiethanol (DEA) and 2,2′,2″-nitrilotriethanol (TEA), and carboxymethylinulin (CMI), and combinations thereof.

The detergent composition may also contain 0-65% by weight of a detergent co-builder, or a mixture thereof. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), etheylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid) (HEDP), ethylenediaminetetrakis(methylene)tetrakis(phosphonic acid) (EDTMPA), diethylenetriaminepentakis(methylene) pentakis (phosphonic acid) (DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N, N-diacetic acid (SLDA), taurine-N, N-diacetic acid (TUDA) and sulfomethyl-N,N-diacetic acid (SMDA), N-(hydroxyethyl)-ethylidenediaminetriacetate (HEDTA), diethanolglycine (DEG), Diethylenetriamine Penta (Methylene Phosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053.

### Bleaching Systems

The detergent may contain 0-40% by weight, such as about 5% to about 25%, of a bleaching system. Any bleaching system known in the art for use in laundry detergents may be utilized. Suitable bleaching system components include bleaching catalysts, photobleaches, bleach activators, sources of hydrogen peroxide such as sodium percarbonate and sodium perborates, preformed peracids and mixtures thereof.

### Polymers

The detergent, in addition to the anti-redeposition polymer as mentioned above, may further contain 0-10% by weight, such as 0.5-5%, 2-5%, 0.5-2% or 0.2-1% of another type of polymer. The polymer may function as a co-builder as mentioned above, or may provide fiber protection, soil release, dye transfer inhibition, grease cleaning and/or anti-foaming properties. Some polymers may have more than one of the above-mentioned properties and/or more than one of the below-mentioned motifs. Any polymer known in the art for use in detergents may be utilized.

### Additional Enzymes

The detergent additive as well as the detergent composition may comprise one or more additional enzymes such as lipases, amylases, hemicellulases, peroxidases, xylanases, phospholipases, esterases, cutinases, keratinases, reductases, oxidases, phenoloxidases, lipoxygenases, ligninases, pullulanases, malanases, β-glucanases, arabinosidases, hyaluronidase, laccase, deoxyribonucleases (DNases), hexosaminidases, and any mixture thereof.

In general the properties of the selected enzyme(s) should be compatible with the selected detergent, (i.e., pH-optimum, compatibility with other enzymatic and non-enzymatic ingredients, etc.), and the enzyme(s) should be present in effective amounts. Generally, when present in a cleaning composition, the enzyme(s) may be present at levels of at least 0.001 mg of enzyme protein, at least 0.006 mg of enzyme protein, at least 0.008 mg of enzyme protein, at least 0.01 mg of enzyme protein, at least 0.1 mg of enzyme protein, at least 0.5 mg of enzyme protein, at least 1 mg of enzyme protein, or at least 2 mg of enzyme protein.

### Formulation of Enzyme in Co-Granule

The enzyme of the invention may be formulated as a granule for example as a co-granule that combines one or more enzymes. Each enzyme will then be present in more granules securing a more uniform distribution of enzymes in the detergent. This also reduces the physical segregation of different enzymes due to different particle sizes. Methods for producing multi-enzyme co-granulates for the detergent industry are disclosed in the IP.com disclosure IPCOM000200739D.

Another example of formulation of enzymes by the use of co-granulates is disclosed in WO 2013/188331, which relates to a cleaning composition comprising (a) a multi-enzyme co-granule; (b) less than 10 wt zeolite (anhydrous basis); and (c) less than 10 wt phosphate salt (anhydrous basis), wherein said enzyme co-granule comprises from 10 to 98 wt % moisture sink component and the composition additionally comprises from 20 to 80 wt % detergent moisture sink component. WO 2013/188331 also relates to a method of treating and/or cleaning a surface, comprising the steps of (i) contacting said surface with the cleaning composition as claimed and described herein in an aqueous wash liquor, (ii) rinsing and/or drying the surface.

The multi-enzyme co-granule may comprise an enzyme of the invention and one or more enzymes selected from the group consisting of lipases, amylases, hemicellulases, peroxidases, xylanases, phospholipases, esterases, cutinases, keratinases, reductases, oxidases, phenoloxidases, lipoxygenases, ligninases, pullulanases, malanases, β-glucanases, arabinosidases, hyaluronidase, laccase, deoxyribonucleases (DNases), hexosaminidases, and any mixture thereof.

The invention is further summarized in the below paragraphs:
1. Use of an enzyme for replacement of a whiteness-maintaining agent in a cleaning composition, wherein the enzyme is selected from the group consisting of a protease, a mannanase, a cellulase and combinations thereof.
2. The use of paragraph 1, wherein the whiteness-maintaining agent is selected from the group consisting of an optical brightener, an anti-redeposition polymer and mixture thereof.
3. The use of paragraph 1 or 2, wherein said replacement is partial or full replacement.
4. The use of any of preceding paragraphs, wherein the enzyme is a combination of a protease and a cellulase.
5. The use of any of preceding paragraphs, wherein the enzyme is a combination of a protease and a mannanase.
6. The use of any of preceding paragraphs, wherein the enzyme is a combination of a cellulase and a mannanase.
7. The use of any of preceding paragraphs, wherein the enzyme is a combination of a protease, a mannanase and a cellulase.
8. The use of any of preceding paragraphs, wherein the protease has at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the polypeptide of SEQ ID NO: 1, 2, 3, 4 or 5.
9. The use of any of preceding paragraphs, wherein the protease is a variant of the polypeptide of SEQ ID NO: 2 comprising an alteration at one or more positions corresponding to positions 3, 4, 9, 15, 43, 68, 76, 99, 101, 103, 104, 160, 167, 170, 194, 199, 205, 206, 209, 217, 218, 222, 245, 261 and 262, wherein position numbers correspond to the positions of SEQ ID NO: 1, wherein each alteration is independently a substitution, deletion or insertion, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to the polypeptide of SEQ ID NO: 2.
10. The use of any of preceding paragraphs, wherein the protease is:
   (a) a variant of the polypeptide of SEQ ID NO: 2, comprising one or more substitutions selected from the group consisting of: S3T, V41, S9E, S9R, A15T, V68A, N76D, S99D, S99G, S99A, S99SE, S101E, S101N, S101R, S103A, V1041, G160S, Y167A, R170S, A194P, V199M, V2051, Q206L, Y209W, L217D, L217Q, N218D, M222S, Q245R, N261W and L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, at least 99%, but less than 100% sequence identity to SEQ ID NO: 2;
   (b) a variant of the polypeptide of SEQ ID NO: 2, comprising the substitutions N76D+Y209W, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
   (c) a variant of the polypeptide of SEQ ID NO: 2, comprising the substitution S87N, wherein the variant has protease activity and wherein the position corresponds to the position of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
   (d) a variant of the polypeptide of SEQ ID NO: 2, comprising the substitutions Y167A+R170S+A194P, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
   (e) a variant of the polypeptide of SEQ ID NO: 2, comprising the substitutions S9E+N43R+N76D+V2051+Q206L+Y209W+S259D+N261W+L262E, wherein position numbers correspond to the positions of SEQ ID NO: 1, and wherein the variant has protease activity and has at least 80, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
   (f) a variant of the polypeptide of SEQ ID NO: 4, comprising the substitutions A68S+T77N+T78|+G127S+A128P+G165Q+N184Q+A202V+N217S+S258P, wherein position numbers correspond to the positions of SEQ ID NO: 4, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 4;
   (g) a variant comprising a substitution at one or more positions corresponding to positions 171, 173, 175, 179 or 180 of SEQ ID NO: 1 of WO2004/067737, wherein the variant has protease activity and has a sequence identity of at least 80%, at least 85%, at least 90%, at least 91%, at least 92%, at least 93%, at least 94%, at least 95%, at least 96%, at least 97%, at least 98%, or at least 99%, but less than 100% to SEQ ID NO: 1 of WO2004/067737;
   (h) a protease variant comprising one or more substitutions compared to a parent protease, selected from the group consisting of X3V, X9 [E, R], X22 [R,A], X43R, X61 [E,D], X62 [E,D], X76 [D], X87N, X101 [E,G,D,N,M], X103A, X1041, X118 [V,R], X120V, X128 [A,L,S], X129Q, X130A, X160D, X185 [E,D], 188 [E,D], X191N, X194P, X2051, X206L, X209W, X216V, X217 [Q,D,E], X218 [D,E,S], X232V, X245R, X248D, X256 [E,D], X259 [E,D], X261 [E,D,W] and X262 [E,D], wherein position numbers correspond to the positions of BPN′ (SEQ ID NO: 1), wherein “X” represents any amino acid residue present in the specified position in the parent protease, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or SEQ ID NO: 2; and
   (i) a protease variant comprising any of the following substitution sets compared to a parent protease, wherein the parent protease has the amino acid sequence of SEQ ID NO: 1 or SEQ ID NO: 2 or has at least 80% sequence identity to SEQ ID NO: 1 or SEQ ID NO: 2, wherein position numbers correspond to the positions of BPN′ (SEQ ID NO: 1), wherein “X” represents any amino acid residue present in the specified position in the parent protease, and wherein the substitution set is selected from the group consisting of:
      i. X9R+X15T+X68A+X218D+X245R,
      ii. X9R+X15T+X68A+X245R,
      iii. X61E+X194P+X2051+X261D,
      iv. X61D+X2051+X245R,
      V. X61E+X194P+X2051+X261D,
      vi. X87N+X118V+X128L+X129Q+X130A,
      vii. X87N+X101M+X118V+X128L+X129Q+X130A,
      viii. X76D+X87R+X118R+X128L+X129Q+X130A,
      ix. X22A+X62D+X101G+X188D+X232V+X245R,
      x. X103A+X1041,
      xi. X22R+X101G+X232V+X245R,
      xii. X103A+X1041+X156D,
      xiii. X103A+X1041+X261E,
      xiv. X62D+X245R,
      XV. X101N+X128A+X217Q,
      xvi. X101E+X217Q,
      xvii. X101E+X217D,
      xviii. X9E+X43R+X262E,
      xix. X76D+X43R+X209W,
      XX. X2051+X206L+X209W,
      xxi. X185E+X188E+X2051,
      xxii. X256D+X261W+X262E,
      xxiii. X191N+X209W,
      xxiv. X261E+X262E,
      xxv. X261E+X262D, and
      xxvi. X167A+X170S+X194P,
   wherein the protease variant has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or 2.
11. The use of any of preceding paragraphs, wherein the protease variant comprises the amino acid sequence of SEQ ID NO: 2 with the substitutions Y167A+R170S+A194P, wherein the variant has protease activity, and wherein position numbers correspond to the positions of SEQ ID NO: 1.
12. The use of any of preceding paragraphs, wherein the protease variant comprises the amino acid sequence of SEQ ID NO: 2 with the substitutions S9E+N43R+N76D+V2051+Q206L+Y209W+S259D+N261W+L262E, wherein the variant has protease activity and wherein position numbers correspond to the positions of SEQ ID NO: 1.
13. The use of any of preceding paragraphs, wherein the protease variant comprises the amino acid sequence of SEQ ID NO: 2 with the substitutions S3T+N43R+N76D+S87N+G118M+S128Q+N184E+V2051+Q206L+Y209W+S259D+N261W+L262E, wherein the variant has protease activity and wherein position numbers correspond to the positions of SEQ ID NO: 1.
14. The use of any of preceding paragraphs, wherein the protease is an enzyme having or consisting of the amino acid sequence of SEQ ID NO: 2, 3, 4 or 5.
15. The use of any of preceding paragraphs, wherein the cellulase is an enzyme having at least 60%, at least 65%, at least 70%, at least 75%, at least 80%, at least 85%, at least 90%, at least 95%, at least 96%, at least 97%, at least 98%, at least 99% or 100% sequence identity to SEQ ID NO: 13, 14, 15, 16, 17, 18, 19, 20, 21, 22 or 23.
16. The use of any of preceding paragraphs, wherein the mannanase is an enzyme having at least 60%, at least 65%, at least 70%, at least 75%, at least 80%, at least 85%, at least 90%, at least 95%, at least 96%, at least 97%, at least 98%, at least 99% or 100% sequence identity to SEQ ID NO: 6, 7, 8, 9, 10, 11 or 12.
17. A cleaning composition free of at least one whiteness-maintaining agent, wherein the composition comprises at least two enzymes selected from the group consisting of a protease, a mannanase and a cellulase.
18. The composition of paragraph 17, wherein the whiteness-maintaining agent is selected from the group consisting of an optical brightener, an anti-redeposition polymer and mixture thereof, and preferably the cleaning composition is a laundry detergent.
19. The composition of paragraph 17 or 18, wherein the enzyme is as defined in any of preceding paragraphs 4-16.
20. The composition of any of preceding paragraphs 17-19, wherein the whiteness performance of the composition is improved compared to a comparable or reference cleaning composition, wherein the reference cleaning composition comprise said at least one whiteness-maintaining agent but free of said enzymes.
21. A method for maintaining or improving the whiteness and/or color of a textile, comprising: (a) exposing said textile to a wash liquor comprising the detergent composition according to any of preceding paragraphs 17-19; and optionally (b) rinsing the textile.

The invention is further illustrated in the following non-limiting examples.

### Examples

### Assay I: Testing of Protease Activity

Proteolytic activity can be determined by a method employing the Suc-AAPF-pNA sub-strate. Suc-AAPF-pNA is an abbreviation for N-Succinyl-Alanine-Alanine-Proline-Phenylalanine-p-Nitroanilide, and is a blocked peptide which can be cleaved by endo-proteases. Following proteolytic cleavage, a free pNA molecule having a yellow color is liberated and can be measured by visible spectrophotometry at wavelength 405 nm. The Suc-AAPF-PNA substrate is manufactured by Bachem (cat. no. L1400, dissolved in DMSO).

The protease sample to be analyzed is diluted in residual activity buffer (100 mM Tris pH 8.6). The assay is performed by transferring 30 μl of diluted enzyme samples to 96 well micro-titer plate and adding 70 μl substrate working solution (0.72 mg/ml in 100 mM Tris pH 9). The solution is mixed at room temperature and absorption is measured every 20 sec. over 5 minutes at OD 405 nm.

The slope (absorbance per minute) of the time dependent absorption-curve is directly proportional to the activity of the protease in question under the given set of conditions. The protease sample should be diluted to a level where the slope is linear.

### Assay II: Testing of Mannanase Activity

Mannanase activity is determined by using insoluble Azo-carob-galactomannan substrate from Megazyme. Substrate was incubated with enzyme for 20 min at 25 ° C, shaking at 800 rpm. The reaction mixture was kept static for 10 min to allow insoluble substrate to settle. Enzyme activity was measured by reading the optical density of supernatant at 590 nm.

### Assay III: Testing of Cellulase Activity

Cellulase activity is determined as the ability of an enzyme to catalyze hydrolysis of 1,4-beta-D-glucosidic linkages in beta-1,4-glucan (cellulose). For purposes of the present invention, cellulase activity is determined using AZCL-HE-cellulose (from Megazyme) as the reaction substrate. Substrate was incubated with enzyme for 20 min at 30 ° C, shaking at 800 rpm. The reaction mixture was kept static for 10 min to allow insoluble substrate to settle. Enzyme activity was measured by reading the optical density of supernatant at 590 nm.

### Detergent:

Model detergent 1 is used, ingredients:
5.3% LAS, 10.7% AEOS, 1% soap, 5.3% non-ionic surfactants AEO, 2% sodium citrate, 0.4% TEA, 0.73 NaOH, 0.02% CaCl2, and add water to 100% (all percentages are w/w)

Model detergent 2 is used, ingredients:
21.0% LAS, 25.0% non-ionic surfactants AEO, 15.0% monopropylene glycol, 9.0% soap, 8.0% glycerol, 6.8% monoethanolamine, 0.5% DTMPA, and add water to 100% (all percentages are w/w).

### Enzymes Used in the Example

Protease: polypeptide of SEQ ID NO: 2 with the following mutations: S9E+N43R+N76D+V2051+Q206L+Y209W+S259D+N261W+L26E, wherein position numbers are based on the numbering of SEQ ID NO: 1.
Mannanase: a mannanase corresponding to the polypeptide of SEQ ID NO: 7.
Cellulase A: a cellulase corresponding to the polypeptide of SEQ ID NO: 18.
Cellulase B: a cellulase corresponding to the polypeptide of SEQ ID NO: 21.
Cellulase C: a cellulase corresponding to the polypeptide of SEQ ID NO: 14.

### Terg-O-Tometer (TOM) Wash Assay

The Tergo-To-Meter (TOM) is a medium scale model wash system that can be applied to test 16 different wash conditions simultaneously. A TOM is basically a large temperature-controlled water bath with up to 16 open metal beakers submerged into it. Each beaker constitutes one small top loader style washing machine and during an experiment, each of them will contain a solution of a specific detergent/enzyme/polymer system and the soiled and unsoiled fabrics its performance is tested on. Mechanical stress is achieved by a rotating stirring arm, which stirs the liquid within each beaker.

In a TOM experiment, factors such as the ballast to soil ratio and the fabric to wash liquor ratio can be varied. Therefore, the TOM provides the link between small scale experiments and the more time-consuming full-scale experiments.

Equipment: The water bath with 16 steel beakers and 1 rotating arm per beaker with capacity of 1L detergent solution. Temperature ranges from 5 ° C to 80 °C. The water bath has to be filled up with deionised water. Rotational speed can be set up to 70 to 120 rpm/min.

Set temperature in the Terg-0-Tometer and start the rotation in the water bath. Wait for the temperature to adjust (tolerance is +/−0,5 ° C). The wash solution or wash liquor with desired amount of detergent, temperature and water hardness is prepared in a bucket. The detergent is allowed to dissolve during magnet stirring for 10 min. Wash solution shall be used within 30 to 60 min after preparation.

1L wash solution is added into a TOM beaker. The wash solution or wash liquor is agitated at 120 rpm and one or more enzymes, optical brighteners or polymers are added to the beaker. The whiteness tracers are sprinkled into the beaker and then the ballast load. Time measurement starts when the swatches and ballast are added to the beaker. The swatches are washed for 20 or 30 minutes after which agitation is terminated.

The wash load is subsequently transferred from the TOM beaker to a sieve and rinse with cold tap water. The soil swatches are separated from the ballast load. The soil swatches are transferred to a 5L beaker with cold tap water under running water for 5 minutes. The ballast load is kept separately for the coming inactivation. The water is gently pressed out of the swatches by hand and placed on a tray covered with a paper. The swatches are allowed to dry overnight before subjecting the swatches to analysis, such as measuring the delta REM.

The wash conditions and materials are listed in below tables 1-2.

TABLE 1
TOM wash conditions

| Wash parameters | 30 °C, 2 g/L Model detergent 1, 14° dH, | |
|---|---|---|
| | Ca2⁺/Mg2⁺/HCO3⁻ | |
| | Ca2⁺/Mg2⁺/HCO3⁻ ratio 2:1:4.5 | |
| Wash cycle | 4 | |
| Detergent | Model detergent 1, 2 g/L | |
| Optical brightener | #31 optical brightener, which is bistriazinyl stilbene | |
| (OB) | derivative, 0.1 wt % relative to detergent amount | |
| Anti-redeposition | ACUSOL ™ 445N Detergent Polymer from DOW, | |
| polymer (ARD | 0.4 wt % relative to detergent amount | |
| polymer) | | |
| Enzyme | Protease: 0.1 ppm in wash solution; | |
| | Mannanase: 0.02 ppm in wash solution; | |
| | Cellulase A: 0.16 ppm in wash solution; | |
| | Cellulase B: 0.11 ppm in wash solution. | |
| Water volume | 1 | L/beaker |
| Rotation | 120 | rpm |
| Wash time | 30 | min |

| | |
|---|---|
| Soil ballast, per | W-SBL 2004, Soil Ballast purchased from CFT |
| beaker | (Center for Testmaterials BV); and |
| | Carbon Black soil purchased from CFT, 7 gram of |
| | carbon black/L |
| Tracer swatch | White tracer set is listed in table 2 below. |
| | 3 pieces of each tracer per beaker. |

TABLE 2
White tracer list

| No. | Name | Producer | Fabric |
|---|---|---|---|
| 1 | W-10A | CFT | WFK standard cotton |
| 2 | W-80 A | (Center for | knitted cotton |
| 3 | Preaged W-80 A | Testmaterials | knitted cotton |
| 4 | CN-42 | BV) | Cotton interlock double jersey |
| 5 | PCN-01 | | Polester/cotton, 65/35, woven |
| 6 | W-20 A | | Polester/cotton, 65/35, woven |
| 7 | T-720 | | Texturized dacron 56T, Double |
| | | | knit jersey (disperse dyeable) |
| 8 | PN-01 | | Bleached woven polyester |
| 9 | Preaged W-30 A | | polester |

### Light Reflectance Measurement

After washing and rinsing the swatches were spread out flat and allowed to air dry at room temperature overnight. Whiteness can be expressed as the Remission (R), which is a measure for the light reflected or emitted from the test material when illuminated with white light. The Remission of the textiles is measured at 460 nm using a Macbeth Color Eye 7000 reflectance spectrophotometer with very small aperture The measurements were made without UV in the incident light and remission at 460 nm (R460) was extracted. The measurements are done per the manufacturer's protocol. Whiteness performance is evaluated by R460 or ΔR460. ΔR460 may be calculated as: R460 value of the tracer washed by detergent+other additives (OB, ARD polymer or enzymes) minus the R460 value of the tracer wash by a comparable detergent e.g., a detergent without at least one of said additives.

### Example 1: Whiteness Performance Evaluation on White Tracers

The Whiteness performance is evaluated by TOM wash assay as set forth above. Wash results are summarized in below tables 3. In below table, sum of R460 (or ΔR460) represents the sum value of R460 (or ΔR460) of the 9 washed white tracers (see table 2). Higher ΔR460 indicates a better whiteness performance/effect of the corresponding detergent composition.

In addition, in below table 3, the whiteness performance brought by addition of enzyme(s), or in other words the whiteness effect (WE) of enzymes for replacing whiteness-maintaining agent, is calculated as:
WE1=Sum of ΔR460 (detergent+enzyme(s)) minus Sum of ΔR460 (detergent+OB+ARD polymer). So, “WE1” indicates the whiteness improvement over a detergent comprising both OB and ARD polymer but free of the enzyme(s) of the invention.
WE2=Sum of ΔR460 (detergent+enzyme(s)) minus Sum of ΔR460 (detergent+OB). So, “WE2” indicates the whiteness improvement over a detergent comprising an optical brightener but free of the enzyme(s) of the invention.

TABLE 3
Sum of remission and delta remission on white tracers washed under different conditions

| | | | Whiteness effect | | | |
|---|---|---|---|---|---|---|
| | | | (WE1) of | | | |
| | | | enzyme(s) for | | Whiteness effect | |
| Conditions | | | replacing both OB | | (WE2) of enzyme(s) for | |
| (Different | | | and polymer | | replacing OB | |
| detergent | | Sum of | enzyme | Synergy | enzyme | Synergy |
| compositions) | Sum of R460 | ΔR460 | effect | effect | effect | effect |
| Detergent | 496.2 | 0 | / | / | / | / |
| Detergent + OB | 508.8 | 12.6 | / | / | / | / |
| Detergent + OB + | 505.2 | 9.0 | / | / | / | / |
| ARD polymer | | | | | | |
| Detergent + | 527.3 | 31.1 | 22.0 | / | 18.5 | / |
| protease | | | | | | |
| Detergent + | 526.7 | 30.5 | 21.5 | / | 17.9 | / |
| mannanase | | | | | | |
| Detergent + | 571.7 | 75.5 | 66.4 | / | 62.9 | / |
| cellulase B | | | | | | |
| Detergent + | 524.9 | 28.7 | 19.7 | / | 16.2 | / |
| cellulase A | | | | | | |
| Detergent + | 565.3 | 69.1 | 60.1 | 18.3 | 56.5 | 21.8 |
| cellulase A + | | | | | | |
| protease | | | | | | |
| Detergent + | 585.0 | 88.8 | 79.8 | 38.6 | 76.3 | 42.1 |
| cellulase A + | | | | | | |
| mannanase | | | | | | |
| Detergent + | 604.3 | 108.1 | 99.0 | 10.6 | 95.5 | 14.1 |
| cellulase B + | | | | | | |
| protease | | | | | | |
| Detergent + | 603.2 | 107.0 | 98.0 | 10.1 | 94.4 | 13.6 |
| cellulase B + | | | | | | |
| mannanase | | | | | | |
| Detergent + | 638.4 | 142.2 | 133.2 | 23.3 | 129.6 | 30.3 |
| cellulase B + | | | | | | |
| Protease + | | | | | | |
| mannanase | | | | | | |
| Detergent + | 638.1 | 141.9 | 132.9 | 69.7 | 129.4 | 76.7 |
| cellulase A + | | | | | | |
| Protease + | | | | | | |
| mannanase | | | | | | |

From table 3 above, it is clear that adding whiteness-maintaining agent (such as OB or ARD polymer) can improve the whiteness performance of a detergent composition, in other words, can prevent/reduce the loss of whiteness of a textile. Replacing said agent with single enzyme (protease, mannanase or cellulase) of the invention can further improve the whiteness performance of the detergent composition.

The results also show that an enzyme combination of a protease, a mannanase and/or a cellulase provides even better whiteness performance as compared to the individual enzymes. This clearly suggests that there is a synergetic effect between the two or three enzymes with regard to improving the whiteness performance of a detergent composition.

### Example 2: Whiteness Performance Evaluation on White Tracers

TABLE 4
TOM wash conditions in European wash conditions

| Wash parameters | 30 °C, 1.8 g/L detergent Model detergent 2, 15° dH, | |
|---|---|---|
| | Ca2⁺/Mg2⁺/HCO3⁻ | |
| | Ca2⁺/Mg2⁺/HCO3⁻ ratio 2:1:7.5 | |
| Wash cycle | 4 | |
| Detergent | Standard Unit Dose Model detergent 2, 1.8 g/L | |
| Optical brightener | Distyryl biphenyl derivative, 0.1 wt % relative to | |
| (OB) | detergent amount | |
| Cleaning polymer | Sokalan ™ HP20 Detergent Polymer from BASF, | |
| | 0.2 wt % relative to detergent amount | |
| Enzyme | Protease: 1.40 ppm in wash solution; | |
| | Mannanase: 0.04 ppm in wash solution; | |
| | Cellulase C: 0.11 ppm in wash solution. | |
| Water volume | 1 | L/beaker |
| Rotation | 120 | rpm |
| Wash time | 20 | min |

| | |
|---|---|
| Soil ballast, per | W-SBL 2004, Soil Ballast purchased from CFT |
| beaker | (Center for Testmaterials BV); and |
| | Carbon Black soil purchased from CFT, 7 gram of |
| | carbon black/L |
| Tracer swatch | White tracer set is listed in table 2 below. |
| | 2 pieces of each tracer per beaker. |

TABLE 5
White tracer list for EU conditions

| No. | Name | Producer | Fabric |
|---|---|---|---|
| 1 | W-10A | CFT | WFK standard cotton |
| 2 | W-80 A | (Center for | knitted cotton |
| 3 | CN-42 | Testmaterials | Cotton interlock double jersey |
| 4 | W-20 A | BV) | Polyester/cotton, 65/35, woven |
| 5 | T-720 | | Texturized dacron 56T, Double knit jersey |
| | | | (disperse dyeable) |
| 6 | PN-01 | | Bleached woven polyester |
| 7 | W-30 A | | polyester |

The Whiteness performance is evaluated by TOM wash assay as set forth above. Wash results are summarized in below table 6. In below table, sum of R460 represents the sum value of R460 of the 7 washed white tracers (see table 5). Higher R460 indicates a better whiteness performance/effect of the corresponding detergent composition.

In addition, in below table 6, the whiteness performance brought by addition of enzyme(s), or in other words the whiteness effect (WE) of enzymes for replacing whiteness-maintaining agent, is calculated as:
WE3=Sum of R460 (detergent+enzyme(s)) minus Sum of R460 (detergent+OB+cleaning polymer). So, “WE3” indicates the whiteness improvement over a detergent comprising both OB and cleaning polymer but free of the enzyme(s) of the invention.
WE4=Sum of R460 (detergent+enzyme(s)) minus Sum of R460 (detergent+OB). So, “WE4” indicates the whiteness improvement over a detergent comprising an optical brightener but free of the enzyme(s) of the invention.
WE5=Sum of R460 (detergent+enzyme(s)) minus Sum of R460 (detergent+cleaning polymer). So, “WE5” indicates the whiteness improvement over a detergent comprising a cleaning polymer but free of the enzyme(s) of the invention.

TABLE 6
Sum of remission and delta remission on white tracers washed under different conditions

| | | | | | | Whiteness effect | |
|---|---|---|---|---|---|---|---|
| | | Whiteness effect | | | | (WE5) of | |
| | | (WE3) of enzyme(s) for | | Whiteness effect | | enzyme(s) for | |
| Conditions | | replacing both OB and | | (WE4) of enzyme(s) | | replacing cleaning | |
| (Different | | polymer | | for replacing OB | | polymer | |
| detergent | Sum of | enzyme | Synergy | enzyme | Synergy | enzyme | Synergy |
| compositions) | R460 | effect | effect | effect | effect | effect | effect |
| Detergent + OB | 513.8 | / | / | / | / | / | / |
| Detergent + | 513.4 | / | / | / | / | / | / |
| cleaning polymer | | | | | | | |
| Detergent + OB + | 514.3 | / | / | / | / | / | / |
| Cleaning | | | | | | | |
| polymer | | | | | | | |
| Detergent + | 582.0 | 61 | / | 68 | / | 69 | / |
| protease | | | | | | | |
| Detergent + | 543.7 | 29 | / | 30 | / | 30 | / |
| mannanase | | | | | | | |
| Detergent + | 530.8 | 15 | / | 17 | / | 17 | / |
| cellulase C | | | | | | | |
| Detergent + | 628.7 | 108 | 32 | 115 | 30 | 115 | 29 |
| cellulase C + | | | | | | | |
| protease | | | | | | | |
| Detergent + | 590.6 | 77 | 33 | 77 | 30 | 77 | 30 |
| cellulase C + | | | | | | | |
| mannanase | | | | | | | |
| Detergent + | 655.8 | 135 | 30 | 142 | 27 | 142 | 26 |
| cellulase C + | | | | | | | |
| Protease + | | | | | | | |
| mannanase | | | | | | | |

From table 6 above, it is clear that replacing whiteness-maintaining agent (such as OB or cleaning polymer) with single enzyme (protease, mannanase or cellulase) of the invention can maintain the same level of whiteness or further improve the whiteness performance of the detergent composition.

The results also show that an enzyme combination of a protease, a mannanase and/or a cellulase provides even better whiteness performance as compared to the individual enzymes. This clearly suggests that there is a synergetic effect between the two or three enzymes with regard to improving the whiteness performance of a detergent composition.

### Example 2: Whiteness Performance Evaluation with Commercial Detergent

TABLE 7
TOM wash conditions in European wash
conditions with commercial detergent

| Wash parameters | 30 °C, 3.3 g/L commercial detergent Ecover Non Bio, | |
|---|---|---|
| | 15° dH, Ca2⁺/Mg2⁺/HCO3⁻ | |
| | Ca2⁺/Mg2⁺/HCO3⁻ ratio 2:1:7.5 | |
| Wash cycle | 4 | |
| Detergent | Ecover Non Bio (Commercial detergent bought from | |
| | the shelf), which is a green detergent not comprising | |
| | Optical Brightener or enzymes on original formulation | |
| Optical brightener | Distyryl biphenyl derivative, 0.1 wt % relative to | |
| (OB) | detergent amount | |
| Enzyme | Protease: 2.56 ppm in wash solution; | |
| | Mannanase: 0.07 ppm in wash solution; | |
| | Cellulase C: 0.20 ppm in wash solution. | |
| Water volume | 1 | L/beaker |
| Rotation | 120 | rpm |
| Wash time | 20 | min |

| | |
|---|---|
| Soil ballast, per | W-SBL 2004, Soil Ballast purchased from CFT |
| beaker | (Center for Testmaterials BV); and |
| | Carbon Black soil purchased from CFT, 7 gram of |
| | carbon black/L |
| Tracer swatch | White tracer set is listed in table 8 below. |
| | 2 pieces of each tracer per beaker. |

The Whiteness performance is evaluated by TOM wash assay as set forth above. Wash results are summarized in below table 8. In below table, sum of R460 (or ΔR460) represents the sum value of R460 (or ΔR460) of the 7 washed white tracers (see table 5). Higher ΔR460 indicates a better whiteness performance/effect of the corresponding detergent composition.

In addition, in below table 6, the whiteness performance brought by addition of enzyme(s), or in other words the whiteness effect (WE) of enzymes for replacing whiteness-maintaining agent, is calculated as:
WE2=Sum of ΔR460 (detergent+enzyme(s)) minus Sum of ΔR460 (detergent+OB). So, “WE2” indicates the whiteness improvement over a detergent comprising an optical brightener but free of the enzyme(s) of the invention.

TABLE 8
Sum of remission and delta remission on white
tracers washed under different conditions

| | | | Whiteness effect |
|---|---|---|---|
| Conditions | | | (WE2) of enzyme(s) |
| (Different detergent | Sum of | Sum of | for replacing OB |
| compositions) | R460 | AR460 | enzyme effect |
| Commercial Detergent | 517.6 | 0 | / |
| Commercial Detergent + OB | 518.8 | 1.2 | / |
| Commercial Detergent + | 651.2 | 133.6 | 132.4 |
| Cellulase C + Protease + | | | |
| mannanase | | | |

From the above table, it is clear that adding whiteness-maintaining agent such as OB not always improve the whiteness performance of a detergent composition, in other words, it might not prevent/reduce the loss of whiteness of a textile. Replacing said agent with a combination of enzymes (protease, mannanase and cellulase) of the invention can further improve the whiteness performance of the detergent composition.

1-15. (canceled)

16. A method of improving the whiteness performance of a cleaning composition, the method comprising replacing a whiteness-maintaining agent in the cleaning composition with an enzyme, wherein the enzyme is selected from the group consisting of a protease, a mannanase, a cellulase and combinations thereof.

17. The method of claim 16, wherein the whiteness-maintaining agent is selected from the group consisting of an optical brightener, an anti-redeposition polymer and mixture thereof.

18. The method of claim 16, wherein the replacement is partial replacement or full replacement of the whiteness-maintaining agent.

19. The method of claim 16, wherein the enzyme is a combination of a protease and a cellulase.

20. The method of claim 16, wherein the enzyme is a combination of a protease and a mannanase.

21. The method of claim 16, wherein the enzyme is a combination of a protease, a mannanase and a cellulase.

22. The method of claim 16, wherein the protease has at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the polypeptide of SEQ ID NO: 1, 2, 3, 4 or 5.

23. The method of claim 16, wherein the protease is a variant of the polypeptide of SEQ ID NO: 2, the variant comprising an alteration at one or more positions corresponding to positions 3, 4, 9, 15, 43, 68, 76, 99, 101, 103, 104, 160, 167, 170, 194, 199, 205, 206, 209, 217, 218, 222, 245, 261 and 262, wherein position numbers correspond to the positions of SEQ ID NO: 1, and wherein each alteration is independently a substitution, deletion or insertion, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to the polypeptide of SEQ ID NO: 2.

24. The method of claim 16, wherein the protease is:
a) a variant of the polypeptide of SEQ ID NO: 2, comprising one or more substitutions selected from the group consisting of: S3T, V41, S9E, S9R, A15T, V68A, N76D, S99D, S99G, S99A, S99SE, S101E, S101N, S101R, S103A, V1041, G160S, Y167A, R170S, A194P, V199M, V2051, Q206L, Y209W, L217D, L217Q, N218D, M222S, Q245R, N261W and L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, at least 99%, but less than 100% sequence identity to SEQ ID NO: 2;
b) a variant of the polypeptide of SEQ ID NO: 2, comprising the substitutions N76D+Y209W, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
c) a variant of the polypeptide of SEQ ID NO: 2, comprising the substitution S87N, wherein the variant has protease activity and wherein the position corresponds to the position of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
d) a variant of the polypeptide of SEQ ID NO: 2, comprising the substitutions Y167A+R170S+A194P, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
e) a variant of the polypeptide of SEQ ID NO: 2, comprising the substitutions S9E+N43R+N76D+V2051+Q206L+Y209W+S259D+N261W+L262E, wherein position numbers correspond to the positions of SEQ ID NO: 1, and wherein the variant has protease activity and has at least 80, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
f) a variant of the polypeptide of SEQ ID NO: 4, comprising the substitutions A68S+T77N+T78I+G127S+A128P+G165Q+N184Q+A202V+N217S+S258P, wherein position numbers correspond to the positions of SEQ ID NO: 4, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 4;
g) a variant comprising a substitution at one or more positions corresponding to positions 171, 173, 175, 179 or 180 of SEQ ID NO: 1 of WO2004/067737, wherein the variant has protease activity and has a sequence identity of at least 80%, at least 85%, at least 90%, at least 91%, at least 92%, at least 93%, at least 94%, at least 95%, at least 96%, at least 97%, at least 98%, or at least 99%, but less than 100% to SEQ ID NO: 1 of WO2004/067737;
h) a protease variant comprising one or more substitutions compared to a parent protease, selected from the group consisting of X3V, X9 [E,R], X22 [R,A], X43R, X61 [E,D], X62 [E,D], X76 [D], X87N, X101 [E,G,D,N,M], X103A, X1041, X118 [V,R], X120V, X128 [A,L,S], X129Q, X130A, X160D, X185 [E,D], 188 [E,D], X191N, X194P, X2051, X206L, X209W, X216V, X217 [Q,D,E], X218 [D,E,S], X232V, X245R, X248D, X256 [E,D], X259 [E,D], X261 [E,D,W] and X262 [E,D], wherein position numbers correspond to the positions of BPN′ (SEQ ID NO: 1), wherein “X” represents any amino acid residue present in the specified position in the parent protease, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or SEQ ID NO: 2; and
i) a protease variant comprising any of the following substitution sets compared to a parent protease, wherein the parent protease has the amino acid sequence of SEQ ID NO: 1 or SEQ ID NO: 2 or has at least 80% sequence identity to SEQ ID NO: 1 or SEQ ID NO: 2, wherein position numbers correspond to the positions of BPN′ (SEQ ID NO: 1), wherein “X” represents any amino acid residue present in the specified position in the parent protease, and wherein the substitution set is selected from the group consisting of:
i. X9R+X15T+X68A+X218D+X245R,
ii. X9R+X15T+X68A+X245R,
iii. X61E+X194P+X2051+X261D,
iv. X61D+X2051+X245R,
v. X61E+X194P+X2051+X261D,
vi. X87N+X118V+X128L+X129Q+X130A,
vii. X87N+X101M+X118V+X128L+X129Q+X130A,
viii. X76D+X87R+X118R+X128L+X129Q+X130A,
ix. X22A+X62D+X101G+X188D+X232V+X245R,
x. X103A+X1041,
xi. X22R+X101G+X232V+X245R,
xii. X103A+X1041+X156D,
xiii. X103A+X1041+X261E,
xiv. X62D+X245R,
xv. X101N+X128A+X217Q,
xvi. X101E+X217Q,
xvii. X101E+X217D,
xviii. X9E+X43R+X262E,
xix X76D+X43R+X209W,
xx. X2051+X206L+X209W,
xxi. X185E+X188E+X2051,
xxii. X256D+X261W+X262E,
xxiii. X191N+X209W,
xxiv. X261E+X262E,
xxv. X261E+X262D, and
xxvi. X167A+X170S+X194P,
wherein the protease variant has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or 2.

25. The method of claim 16, wherein the protease is a variant comprising the amino acid sequence of SEQ ID NO: 2 with the substitutions Y167A+R170S+A194P, wherein the variant has protease activity, and wherein position numbers correspond to the positions of SEQ ID NO: 1.

26. The method of claim 16, wherein the protease is a variant comprising the amino acid sequence of SEQ ID NO: 2 with the substitutions S9E+N43R+N76D+V2051+Q206L+Y209W+S259D+N261W+L262E, wherein the variant has protease activity and wherein position numbers correspond to the positions of SEQ ID NO: 1.

27. The method of claim 16, wherein the protease is a variant comprising the amino acid sequence of SEQ ID NO: 2 with the substitutions S3T+N43R+N76D+S87N+G118M+S128Q+N184E+V2051+Q206L+Y209W+S259D+N261W+L262E, wherein the variant has protease activity and wherein position numbers correspond to the positions of SEQ ID NO:
1.

28. The method of claim 16, wherein the protease is an enzyme having or consisting of the amino acid sequence of SEQ ID NO: 2, 3, 4 or 5.

29. The method of claim 16, wherein the cellulase is an enzyme having at least 60%, at least 65%, at least 70%, at least 75%, at least 80%, at least 85%, at least 90%, at least 95%, at least 96%, at least 97%, at least 98%, at least 99% or 100% sequence identity to SEQ ID NO: 13, 14, 15, 16, 17, 18, 19, 20, 21, 22 or 23.

30. The method of claim 16, wherein the mannanase is an enzyme having at least 60%, at least 65%, at least 70%, at least 75%, at least 80%, at least 85%, at least 90%, at least 95%, at least 96%, at least 97%, at least 98%, at least 99% or 100% sequence identity to SEQ ID NO: 6, 7, 8, 9, 10, 11 or 12.

31. The method of claim 16, wherein the cleaning composition is a laundry detergent.

32. The method of claim 16, wherein the whiteness performance of the composition is improved compared to a comparable or reference cleaning composition, wherein the comparable or reference cleaning composition comprises at least one whiteness-maintaining agent and is free of said enzymes.

33. An improved cleaning composition comprising an enzyme selected from the group consisting of a protease, a mannanase, a cellulase and combinations thereof, and wherein composition is free of at least one whiteness-maintaining agent.

34. A method of improving the whiteness or color of a textile, the method comprising contacting the textile to a wash liquor comprising a cleaning composition of claim 32, and, optionally, rinsing the textile, wherein the resultant textile has improved whiteness or color, as compared to a textile not contacted with such wash liquor.
